(19) United States
(12) Patent Application Publication
(10) Pub. No.: US 2003/0129469 A1
(43) Pub. Date: Jul. 10, 2003

(54) Fuel cell with fuel concentrate metering

(76) Inventors: Hoi-Cheong Steve Sun, Dayton, NJ (US); Peter James Coyle, Newtown, PA (US); Rosalyn Ritts, Princeton, NJ (US); Steven Alan Lipp, West Windsor, NJ (US); Richard T. Whipple, Raritan, NJ (US); Grzegorz Kaganowicz, Belle Mead, NJ (US)

Correspondence Address: Arnold H. Krumholz, Lerner, David, Littenberg, Krulholz & Mentlik, LLP, 600 South Avenue West, Westfield, NJ, 07090, US

(21) Appl. No.: 10/123,039

(22) Filed: Apr. 15, 2002

Related U.S. Application Data
(60) Provisional application No. 60/283,823, filed on Apr. 13, 2001.
(60) Provisional application No. 60/283,717, filed on Apr. 13, 2001.
(60) Provisional application No. 60/339,117, filed on Dec. 11, 2001.
(60) Provisional application No. 60/283,786, filed on Apr. 13, 2001.
(60) Provisional application No. 60/357,481, filed on Feb. 15, 2002.
(60) Provisional application No. 60/283,719, filed on Apr. 13, 2001.
(60) Provisional application No. 60/357,367, filed on Feb. 15, 2002.

(51) Int. Cl. H01M 8/02; H01M 8/10

(52) U.S. Cl. 429/34; 429/30; 429/13

(57) ABSTRACT

Also provided is a fuel cell system comprising (1) a fuel cell with an anode compartment and a cathode compartment adapted to operate with a least one liquid consumable comprising (i) a liquid fuel composition or (ii) liquid electron acceptor composition, and: (2) one or both of (a) a fuel reservoir comprising liquid fuel composition separated from the anode compartment by a porous membrane that is selected to not be wetted by either the liquid fuel composition or a solvent/solution with which the anode chamber is adapted to operate or (b) a liquid fuel composition reservoir separated from the cathode compartment by a porous membrane that is selected to not be wetted by either the liquid fuel composition or a composition with which the cathode chamber is adapted to operate.

The present invention relates to fuel cells, including re-chargeable fuel cells, for use in powering electrical devices.

Fuel cells are useful for the direct conversion of chemical energy into electrical energy. Fuel cells are typically made up of two chambers separated by two porous electrodes and an intervening electrolyte. A fuel chamber serves to introduce a fuel, typically hydrogen gas, which can be generated in situ by “reforming” hydrocarbons such as methane with steam, so that the hydrogen contacts H₂O at the first electrode, where, when a circuit is formed between the electrodes, a reaction producing electrons and hydronium (H₃O⁺) ions is catalyzed.

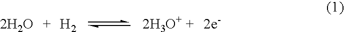

The electrolyte acts to convey hydrogen ions from the first electrode to the second electrode. The second electrode provides an interface with a recipient molecule, typically oxygen, found in the second chamber. The recipient molecule receives the electrons conveyed by the circuit.

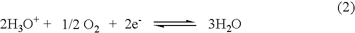

The electrolyte element of the fuel cell can be, for example, a conductive polymer material such as a hydrated polymer containing sulfonic acid groups on perfluoroethylene side chains on a perfluoroethylene backbone such as Nafion™ polymer (du Pont de Nemours, Wilmington, Del.) or like polymers such as those available from Dow Chemical Co. (Midland, Mich.). Other electrolytes include alkaline solutions (such as 35 wt %, 50 wt % or 85 wt % KOH), acid solutions (such as concentrated phosphoric acid), molten electrolytes (such as molten metal carbonate), and solid electrolytes (such as solid oxides such as yttria (Y₂O₃)-stabilized zirconia (ZrO₂)). Liquid electrolytes are often retained in a porous matrix. Such fuel cells are described, for example, in “Fuel Cells,” Kirk-Othmer Encyclopedia of Chemical Technology, Fourth Edition, Vol. 11, pp. 1098-1121.

The shortcomings of traditional fuel cell technology include short operational lifetimes due to catalyst poisoning from contaminants, high initial costs, and the practical restrictions on devices that operate at relatively high to extremely high temperatures, such as 80° C. to 1000° C.

In one aspect, the present invention provides a fuel cell technology that employs molecules used in biological processes to create fuel cells that can operate at moderate temperatures and without the presence of harsh chemicals maintained at high temperatures, which can lead to corrosion of the cell components. While the fuels used in the fuel cells of the invention are more complex, they are readily available and suitably priced for a number of applications, such as power supplies for mobile computing, digital imagers, portable electronic games, audio devices or telephone devices. It is anticipated that fuel cells of the invention can be configured such that a 300 cc cell has a capacity comparable to or more than that of a comparably sized battery for a laptop computer. Thus, it is believed that the fuel cells of the invention can be used to increase capacity, and/or decrease size and weight. Moreover, the compact, inert energy sources of the invention can be used to provide microscale power for short duration electrical output. Since the materials retained within the fuel cells are non-corrosive and typically not otherwise hazardous, it is practical to recharge the fuel cells with fuel, with the recharging done by the consumer or through a service such as a mail order service.

Moreover, in certain aspects, the invention provides fuel cells that use active transport of protons to increase sustainable efficiency.

### SUMMARY OF THE INVENTION

In one embodiment, provided is a fuel cell with an anode compartment and a cathode compartment comprising: in the anode compartment, an anode electrode and one or more dehydrogenase enzymes effective to transfer electrons from a C1 compound comprising carbon, oxygen and hydrogen (optionally consisting of carbon, oxygen and hydrogen) to electron carrier(s), and wherein or further comprising one of the following:

(i) the electron carrier(s) are selected to operate with the dehydrogenase enzymes and to be effective to deliver electrons to the anode electrode,

(ii) the electron carrier(s) are selected to operate with the dehydrogenase enzymes and to be effective to deliver electrons to electron transfer mediator(s) selected to be effective to deliver electrons to the anode electrode, wherein the anode compartment further comprises the electron transfer mediator(s),

(iii) the electron carrier(s) are selected to operate with the dehydrogenase enzymes and to be effective to deliver electrons to a redox enzyme, the redox enzyme is selected to be effective to deliver electrons to second electron carrier(s), the second electron carrier(s) selected to be effective to deliver electrons to electron transfer mediator(s) selected to be effective to deliver the electrons to the anode electrode, wherein the anode compartment further comprises the redox enzyme, second electron carrier(s) and electron transfer mediator(s);

in the cathode compartment, a cathode electrode which, when a conductive pathway to the first electrode is formed, is effective to convey the electrons to an electron acceptor composition in the cathode compartment; and a barrier separating the anode compartment from the cathode compartment but effective to convey protons from the anode compartment to the cathode compartment.

In another embodiment, provided is a method of producing electrical power comprising: in an anode compartment, enzymatically reducing electron carrier(s) with electrons from a C1 compound, the electron carrier(s) selected to operate with the dehydrogenase enzymes; directly transferring the electrons from the electron carrier(s) to an anode electrode; transferring electrical current via an electrical conduit under an electrical load to a cathode electrode; and transferring the electrons from the cathode electrode to an electron acceptor composition. Note that reference to “the” electrons refers to electrons available due to the previously recited electrons.

In yet another embodiment, provided is a method of producing electrical power comprising: in an anode compartment, enzymatically reducing electron carrier(s) with electrons from a C1 compound, the electron carrier(s) selected to operate with the dehydrogenase enzymes; directly transferring the electrons from the electron carrier(s) to the electron transfer mediator(s); transferring the electrons from the electron transfer mediator(s) to the anode electrode; transferring electrical current via an electrical conduit under an electrical load to a cathode electrode; and transferring the electrons from the cathode electrode to an electron acceptor composition.

In yet another embodiment, provided is a method of producing electrical power comprising: in an anode compartment, enzymatically reducing electron carrier(s) with electrons from a C1 compound, the electron carrier(s) selected to operate with the dehydrogenase enzymes; enzymatically transferring the electrons from the electron carrier(s) to second electron carrier(s); directly transferring the electrons from the second electron carrier(s) to the electron transfer mediator(s); transferring electrons from the electron transfer mediator(s) to the anode electrode; transferring electrical current via an electrical conduit under an electrical load to a cathode electrode; and transferring electrons from the cathode electrode to an electron acceptor composition.

In yet another embodiment, provided is a fuel cell with an anode compartment and a cathode compartment comprising: in the anode compartment, an anode electrode and electron carrier(s); in the anode compartment, one or more dehydrogenase enzymes effective to transfer electrons from a C1 compound to an electron carrier; in the cathode compartment, a cathode electrode which, when a conductive pathway to the first electrode is formed, is effective to convey the electrons to an electron acceptor composition in the cathode compartment; and a barrier separating the anode compartment from the cathode compartment but comprising a proton pumping polypeptide effective to transport protons from the anode compartment to the cathode compartment.

In yet another embodiment, provided is a method of producing electrical power comprising: in an anode compartment, enzymatically reducing electron carrier(s) with electrons from a C1 compound, the electron carrier(s) selected to operate with the dehydrogenase enzymes; enzymatically transferring the electrons from the electron carrier(s) to the redox enzyme; transferring the electrons from the redox enzyme to electron transfer mediator(s); transferring the electrons from the electron transfer mediator(s) to the anode electrode; transferring electrical current via an electrical conduit under an electrical load to a cathode electrode; and transferring the electrons from the cathode electrode to an electron acceptor composition.

Also provided is a method of forming a biocompatible membrane that incorporates a polypeptide associated with the biocompatible membrane comprising: contacting an aperture with a mixture of polypeptide, membrane-forming amphiphile and an amount of solvent miscible with a water and biomembrane phase effective to decrease viscosity sufficiently to facilitate biocompatible membrane formation; and removing the solvent by evaporation, thereby filling the aperture. Further provided is a biocompatible membrane comprising a membrane-like barrier formed of block copolymer that comprises cross-linked polymer formed across an aperture with beveled edges. In one embodiment, the biocompatible membrane incorporates a membrane-associated polypeptide. Still further provided is a method of preserving the function of a polypeptide in the presence of non-aqueous solvents comprising: forming a solution of block copolymers in a solvent comprising at least one non-aqueous solvent, and subsequently adding polypeptide to the solution.

In yet another embodiment, provided is a fuel cell with an anode compartment and a cathode compartment comprising: in the anode compartment, an anode electrode and one or more dehydrogenase enzymes effective to transfer electrons from a C1 compound to an electron carrier, the anode compartment further comprising a liquid for supporting the dehydrogenase enzymes and adapted to maintain during operation of the fuel cell a pH of 8.0 or higher; in the cathode compartment, hydrogen peroxide and a cathode electrode which, when a conductive pathway to the first electrode is formed, is effective to convey the electrons to an electron acceptor composition in the cathode compartment, the anode adapted to maintain during operation of the fuel cell a pH of 5.0 or lower; and a barrier separating the anode compartment from the cathode but effective to convey protons from the anode compartment to the cathode compartment.

Also provided is a fuel cell system comprising (1) a fuel cell with an anode compartment and a cathode compartment adapted to operate with a least one liquid consumable comprising (i) a liquid fuel composition or (ii) liquid electron acceptor composition, and: (2) one or both of (a) a fuel reservoir comprising liquid fuel composition separated from the anode compartment by a porous membrane that is selected to not be wetted by either the liquid fuel composition or a solvent/solution with which the anode chamber is adapted to operate or (b) a liquid fuel composition reservoir separated from the cathode compartment by a porous membrane that is selected to not be wetted by either the liquid fuel composition or a composition with which the cathode chamber is adapted to operate.

Further provided is a fuel cell system comprising a fuel cell with an anode compartment and a cathode compartment and using one or both of (a) a liquid fuel composition or (b) a liquid electron acceptor composition, the fuel cell comprising:

in the anode compartment, an anode electrode adapted to operate with a fuel;

in the cathode compartment, a cathode electrode which, when a conductive pathway to the anode electrode is formed, is effective to convey the electrons to an electron acceptor composition in the cathode compartment;

and a barrier separating the anode compartment from the cathode compartment but effective to convey protons from the anode compartment to the cathode compartment; and

one or both of (a) a fuel reservoir comprising a liquid fuel composition separated from the anode compartment by a porous membrane that is selected to not be wetted by either the liquid fuel composition or a solvent/solution with which the anode chamber is adapted to operate or (b) a liquid electron acceptor composition reservoir separated from the anode compartment by a porous membrane that is selected to not be wetted by either the liquid electron acceptor composition of the reservoir or a composition with which the cathode chamber is adapted to operate.

Further provided is a method of operating a fuel cell comprising: consuming (i) a fuel molecule or (ii) an electron acceptor molecule during operation of the fuel cell; and transporting (i) fuel molecule or (ii) electron acceptor molecule via the vapor phase to a chamber in which the respective fuel molecule or electron acceptor molecule is consumed.

Also provided is a fuel cell system comprising a fuel cell with an anode compartment and a cathode compartment, the fuel cell comprising:

in the anode compartment, an anode electrode, wherein the anode compartment is adapted to generate CO2;

in the cathode compartment, a cathode electrode which, when a conductive pathway to the first electrode is formed, is effective to convey the electrons to an electron acceptor composition in the cathode compartment; and

a barrier separating the anode compartment from the cathode compartment but effective to convey protons from the anode compartment to the cathode compartment; and

a CO2 permeable membrane or porous material adapted to allow CO2 to exit the anode compartment.

Still further provided is a method of operating a fuel cell comprising: consuming in an anode compartment a fuel to generate CO2 during operation of the fuel cell; removing CO2 derived from the C1 compound from the anode compartment; and replacing liquid volume in the anode compartment consumed by operation of the fuel cell and CO2 removal with replacement fuel.

Also provided is a device for metering a reactant concentrate comprising: a first chamber adapted for containing reactant concentrate; a second chamber adapted for receiving reactant concentrate from the first chamber; and a membrane separating the first and second chambers comprising pores traversing from a first chamber side of the membrane to a second chamber side of the membrane, and internal conduit in the membrane effective to deliver gas to the pores.

Further provided is a fuel cell adapted for use with an anode composition, the fuel cell comprising: an anode/cathode barrier that selectively transmits protons; an anode chamber comprising a grid of porous material selected to not be wetted by the anode composition and to transmit CO2; and a manifold connected to the grid to collect CO2 transmitted through the grid.

Still further provided is a fuel cell with an anode compartment and a cathode compartment comprising: in the anode compartment, an anode electrode and, integrated into biocompatible membrane tethered to the anode electrode, a redox enzyme that can receive electrons from an electron carrier; in the cathode compartment, a cathode electrode which, when a conductive pathway to the first electrode is formed, is effective to convey the electrons to an electron acceptor composition in the cathode compartment; and a barrier separating the anode compartment from the cathode compartment but effective to convey protons from the anode compartment to the cathode compartment.

Also provided is a fuel cell with an anode compartment and a cathode compartment comprising: in the anode compartment, an anode electrode and, associated with or adjacent to the anode electrode, a redox enzyme incorporated into a synthetic membrane comprising a block copolymer, wherein the redox enzyme can receive electrons from an electron carrier; in the cathode compartment, a cathode electrode which, when a conductive pathway to the first electrode is formed, is effective to convey the electrons to an electron acceptor composition in the cathode compartment; and a barrier separating the anode compartment from the cathode compartment but effective to convey protons from the anode compartment to the cathode compartment.

Additionally provided is a fuel cell with an anode compartment, a cathode compartment and a barrier separating the anode compartment from the cathode compartment but effective to convey protons from the anode compartment to the cathode compartment, comprising in the anode compartment, one or more anode electrodes and, one or more dehydrogenase enzymes effective to transfer electrons from a C1 compound to electron carrier(s), wherein one or more of the said enzyme(s) are covalently linked to surface(s) within the anode compartment. Also provided is a fuel cell with an anode compartment, a cathode compartment and a barrier separating the anode compartment from the cathode compartment but effective to convey protons from the anode compartment to the cathode compartment, comprising in the anode compartment, one or more anode electrodes and, one or more dehydrogenase enzymes effective to transfer electrons from a C1 compound to electron carrier(s), wherein one or more of the said enzyme(s) are covalently linked to a polymer matrix within the anode compartment. When the dehydrogenase enzymes are covalently linked within the anode compartment, useful surfaces include: the anode/cathode barrier, one or more of the anode electrodes, beads or gels in the anode compartment, anode walls and fuel feeding membrane(s).

Still further provided is a fuel cell with an anode compartment and a cathode compartment adapted to operate with a hydrogen peroxide as electron acceptor molecule, the fuel cell comprising: a first barrier separating the anode compartment and the cathode compartment, but effective to transport protons from the anode compartment to the cathode compartment; and a second barrier separating the anode compartment and the cathode compartment, which is more proximate to the cathode compartment than the first, wherein the second barrier is a biocompatible membrane or a proton-conductive polymeric membrane, the second barrier fitted to limit the diffusion of hydrogen peroxide to the first barrier.

### BRIEF DESCRIPTION OF THE DRAWINGS

FIGS. 1 and 2 schematically illustrate fuel cells.

FIG. 3A illustrates a proton-conductive divider between an anode and a cathode chamber.

FIG. 3B shows an expanded, schematic view of a proton conductive divider, while FIG. 3C shows such a divider in the context of a cell housing. The schematic of FIG. 3D is more realistic as to the structure of the biocompatible membrane, while that of FIG. 3E shows another placement of the electrodes.

FIG. 4 illustrates the use of reservoirs in conjunction with the anode or cathode chamber.

FIGS. 5A and 5B show the operation of vapor phase gating of fuel or electron acceptor. FIG. 6 illustrates wicking systems for delivering fuel or electron acceptor.

FIGS. 7A and 7B illustrate the use of anchored biocompatible membrane.

FIGS. 8A-8D and 9 further illustrate devices for delivering fuel or electron acceptor.

FIG. 10 illustrates another device for delivering fuel.

FIGS. 11A-11D illustrate a device for regulating fuel (or electron acceptor molecule composition) distribution across a porous membrane to the anode (or cathode) compartment.

FIGS. 12A-12B show a device for delivering fuel concentrate, and removing CO₂.

FIGS. 13A-13E show a device for withdrawing CO₂.

FIGS. 14A to 14C show biocompatible membranes formed across an aperture with bevelled edges.

### DETAILED DESCRIPTION OF THE INVENTION

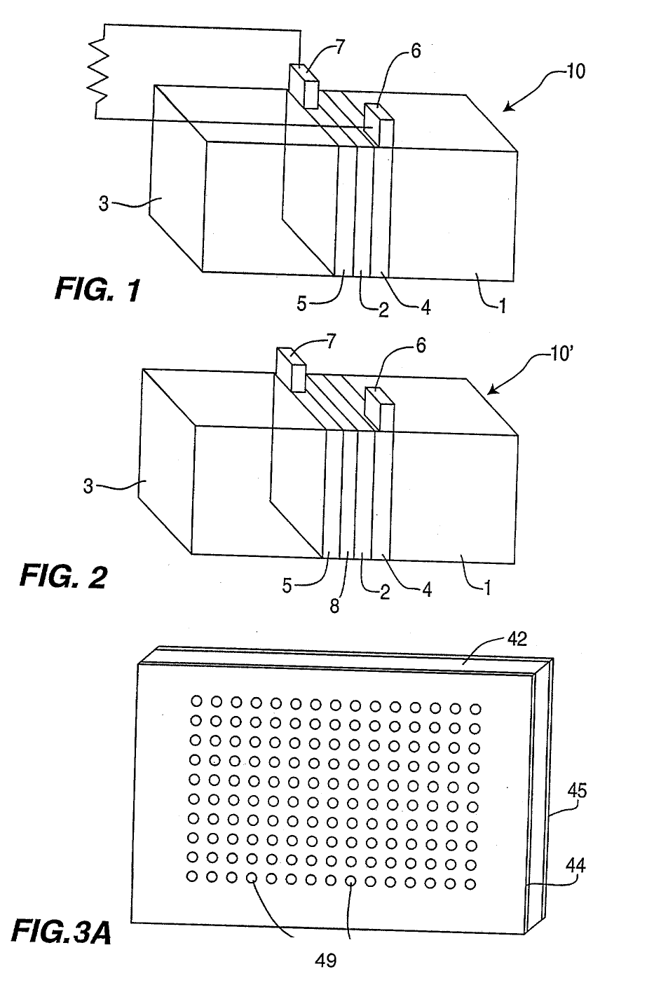

FIG. 1 illustrates features of an exemplary fuel cell 10. The fuel cell 10 has a first (anode) chamber 1 containing an electron carrier, with the textured background fill of the first chamber 1 illustrating that the solution can be retained within a porous matrix (including a porous polymeric membrane). Second (intermediate) chamber or porous polymeric membrane 2 (“anode/cathode barrier”) similarly contains an electrolyte (which can be the same material as found in the first chamber) in a space, which space can also be filled with a retaining matrix, intervening between porous first electrode 4 and porous second electrode 5. A face of second electrode 5 contacts the space of third (cathode) chamber 3, into which an electron acceptor molecule, such as oxygen or a peroxide, is introduced. First electrical contact 6 and second electrical contact 7 allow a circuit to be formed between the two electrodes.

The reaction, typically catalyzed by redox enzymes, that occurs at the first (anode) electrode can be exemplified with NADH as follows:

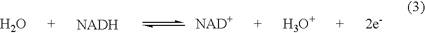

This reaction can be fed by the following reactions:

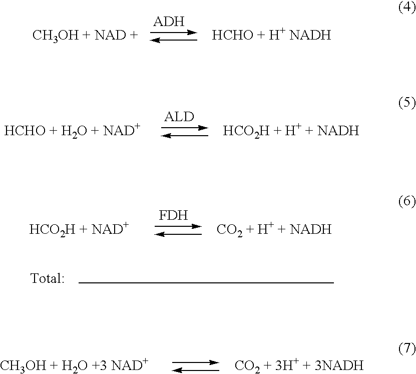

Thus, the feeder reactions and the electron-generating reaction sum as follows:

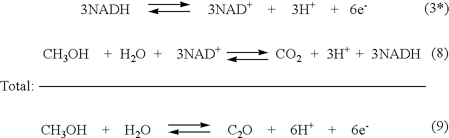

In some embodiments, redox enzymes can relay the electrons to electron transfer mediators that convey the electrons to the anode electrode. Thus, if an enzyme normally conveys the electrons to reduce a small molecule (such as in the reverse of reactions 4-6), this small molecule in some embodiments is bypassed. Fuels that can be used include, in addition to methanol and more direct methanol analogs, oxalic acid, methylformate, dimethyloxalate, and the like. Certain microbial enzyme systems can utilize compounds that incorporate nitrogen and phosphorous.

The feeder enzymes that can be used to generate a reduced electron carrier (such as NADH as illustrated above) from an organic molecule such as methanol can start with a form of alcohol dehydrogenase (ADH). Suitable ADH enzymes are described for example in Ammendola et al., “Thermostable NAD(+)-dependent alcohol dehydrogenase from Sulfolobus solfataricus: gene and protein sequence determination and relationship to other alcohol dehydrogenases,” Biochemistry 31: 12514-23, 1992; Cannio et al., “Cloning and overexpression in Escherichia coli of the genes encoding NAD-dependent alcohol dehydrogenase from two Sulfolobus species,” J. Bacteriol. 178: 301-5, 1996; Saliola et al., “Two genes encoding putative mitochondrial alcohol dehydrogenases are present in the yeast Kluyveromyces lactis,” Yeast 7: 391-400, 1991; and Young et al., “Isolation and DNA sequence of ADH3, a nuclear gene encoding the mitochondrial isozyme of alcohol dehydrogenase in Saccharomyces cerevisiae,” Mol. Cell Biol. 5: 3024-34, 1985. If the resulting formaldehyde is oxidized, an aldehyde dehydrogenase (ALD) is used. Suitable ALD enzymes are described for example in Peng et al., “cDNA cloning and characterization of a rice aldehyde dehydrogenase induced by incompatible blast fungus,” GeneBank Accession AF323586; Sakano et al., “Arabidopsis thaliana [thale cress] aldehyde dehydrogenase (NAD+)-like protein” GeneBank Accession AF327426. If the further resulting formic acid is oxidized, a formate dehydrogenase (FDH) is used. Suitable FDH enzymes are described for example in Colas des Francs-Small, et al., “Identification of a major soluble protein in mitochondria from nonphotosynthetic tissues as NAD-dependent formate dehydrogenase [from potato],” Plant Physiol. 102(4): 1171-1177, 1993; Hourton-Cabassa, “Evidence for multiple copies of formate dehydrogenase genes in plants: isolation of three potato fdh genes, fdh1, fdh2, and fdh3,” Plant Physiol. 117: 719-719, 1998.

For reasons discussed below, it can be useful to use feeder enzymes that are adapted to use or otherwise can accommodate quinone-based electron acceptors. Such enzymes are, for example, described in: Pommier et al., A second phenazine methosulphate-linked formate dehydrogenase isoenzyme in Escherichia coli, Biochim Biophys Acta. 1107(2):305-13, 1992 (“The diversity of reactions involving formate dehydrogenases is apparent in the structures of electron acceptors which include pyridine nucleotides, 5-deazaflavin, quinones, and ferredoxin”); Ferry, Formate dehydrogenase, FEMS Microbiol Rev. 7(3-4):377-82, 1990 (formaldehyde dehydrogenase with quinone activity); Klein et al., A novel dye-linked formaldehyde dehydrogenase with some properties indicating the presence of a protein-bound redox-active quinone cofactor, Biochem J. 301 (Pt 1):289-95, 1994 (representative of a number of articles on dehydrogenases with bound quinone cofactors); Goodwin et al., The biochemistry, physiology and genetics of PQQ and PQQ-containing enzymes, Adv. Microb. Physiol. 40:1-80, 1998 (on alcohol dehydrogenases that utilize quinones); Maskos et al., Mechanism of p-nitrosophenol reduction catalyzed by horse liver and human pi-alcohol dehydrogenase (ADH), J. Biol. Chem. 269(50):31579-84, 1994 (example of mediator-catalyzed transfer of electrons from NADH to an electrode following NADH reduction by an enzyme); and Pandey, Tetracyanoquinodimethane-mediated flow injection analysis electrochemical sensor for NADH coupled with dehydrogenase enzymes, Anal. Biochem. 221(2):392-6, 1994.

The above described feeder enzymes for generating the reduced form of electron carriers from methanol are particularly desirable, since the energy density of methanol as fully consumed to carbon dioxide is high, and the pathway to full consumption involves only a few enzymes. Of course, it will be recognized that other feeder organic molecules other than methanol can be used if these feeder molecules are precursors to oxidized C1 molecules, with the feeder enzymes adjusted as needed to accommodate this fuel. Precursors include for example trioxane, polymers of formaldehyde, methylether, methylformate and formate anhydride. The feeder reactions may or may not proceed to the endpoint of generating carbon dioxide. Or, the feeder reaction may start with a more oxidized fuel, such as formaldehyde or formic acid (or a salt thereof).

The corresponding reaction at the second (cathode) electrode can be any reaction that consumes the produced electrons with a useful redox potential. Using oxygen, for example, the reaction can be:

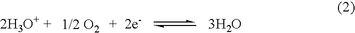

Using reaction 2, the bathing solution can be buffered to account for the consumption of hydrogen ions, hydrogen ion donating compounds can be supplied during operation of the fuel cell, or more preferably, the barrier between the anode and cathode compartments is sufficiently effective to deliver the neutralizing hydrogen ions.

In one embodiment, the corresponding reaction at the second (cathode) electrode is:

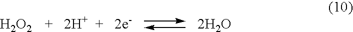

The cathode reactions result in a net production of water, which, if significant, can be dealt with by, for example, providing for space for overflow liquid, or providing for vapor-phase exhaust as described below. A number of electron acceptor molecules are often solids at operating temperatures or solutes in a carrier liquid, in which case the third chamber 3 should be adapted to carry such non-gaseous material. Where, as possibly with hydrogen peroxide, the electron acceptor molecule can damage the enzymes of the anode chamber, the second chamber 2 can have a segment, as illustrated as item 8 in fuel cell 10′ of FIG. 2, containing a scavenger for such electron acceptor molecule. Such a scavenger can be, for example, the enzyme catalase (2H₂O₂→2H₂O+O₂), especially where conditions at the anode electrode are not effective to catalyze electron transfer to O₂. Alternatively, the scavenger can be any noble metal, such as gold or platinum. Such a scavenger, where an enzyme, can be covalently linked to a solid support material. Alternatively, the barrier between the anode chamber and the cathode chamber has at most limited permeability to hydrogen peroxide.

Solid oxidants, such as potassium perchlorite (KClO₄) or potassium permanganate (KMnO₄), can be used as the electron acceptor.

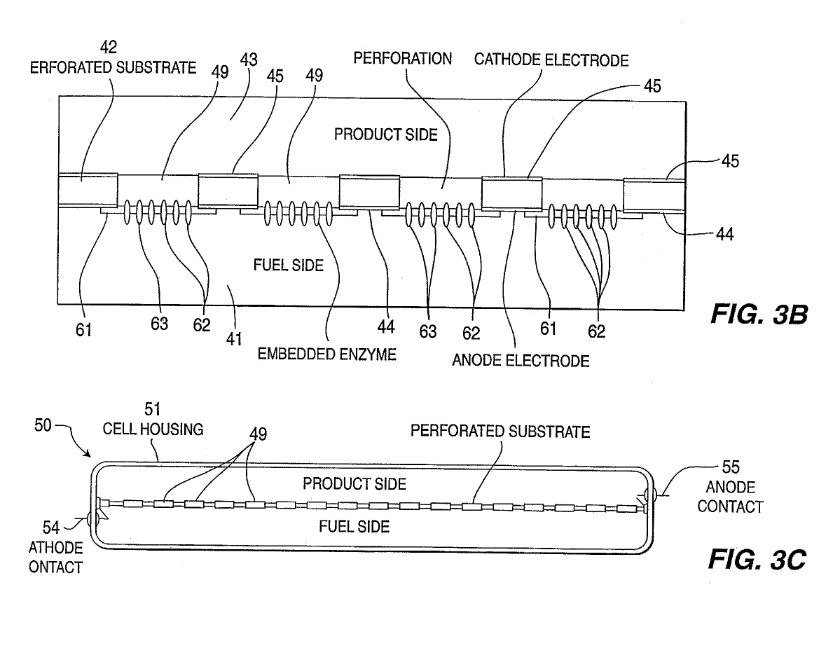

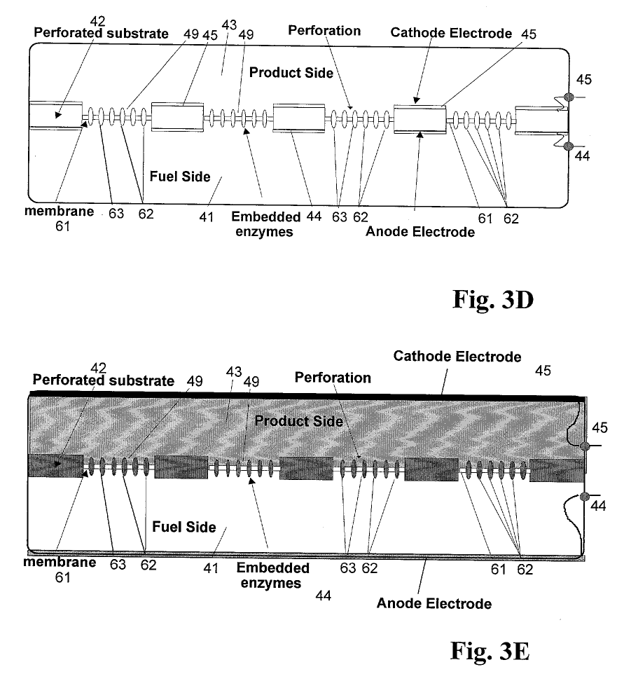

In one embodiment, the electrodes comprise metallizations on one or both sides of a non-conductive (for electrons) substrate such a polymeric membrane or a material that selectively transports protons. For example, in FIG. 3A the metallization on a first side of dielectric substrate 42 is the anode electrode 44, while the metallization on the second side is the cathode electrode 45. Perforations 49 function as the conduit between the anode and cathode of the fuel cell, as discussed further below. The illustration of FIG. 3A, it will be recognized, is illustrative of the relative geometry of this embodiment. The thickness of dielectric substrate 42 is, for example, from 15 micrometer (μm) to 100 micrometer, or from 15 to 50 micrometer, or, preferably, from 15 micrometer to 30 micrometer. The width of the perforations is, for example, from 10 micrometer to 1,000 micrometer, or 20 to 200 micrometer, or, preferably, 60 to 140 micrometer. Preferably, perforations comprise in excess of 30% of the area of any area of the dielectric substrate involved in transport between the chambers, such as from 50 to 75% of the area. In certain preferred embodiments, the dielectric substrate is glass or an polymer (such as polyvinyl acetate, polydimethylsiloxane (PDMS), Kapton® (polyimide film, Dupont de Nemours, Wilmington, Del.), a perfluorinated polymer (such as Teflon, from DuPont de Nemours, Willmington, Del.), polyvinylidene fluoride (PVDF, e.g., a semi-crystalline polymer containing approximately 59% fluorine sold as Kynar™ by Atofina, Philadelphia, Pa.), PEEK (defined below), polyester, UHMWPE (described below), polypropylene or polysulfone), soda lime glass or borosilicate glass, or any of the foregoing coated with metal. The metal can be used to anchor biocompatible membrane (such as a monolayer or bilayer of amphiphilic molecules). The metal coated can be receded from any junctions in which they provide too likely a pathway for a short between the anode and cathode compartments.

FIG. 3B illustrates the electrodes framed on a perforated substrate in more detail. The perforations 49 together with the dielectric substrate 42 (which here defines the anode/cathode barrier) can provide a support for monolayers or bilayers of lipid or other suitable amphipathic molecules (i.e., biocompatible membranes) spanning the perforations. Such biocompatible membranes can incorporate at least a first enzyme or enzyme complex (hereafter “first enzyme”) 62 effective preferably (i) to transport protons from the fuel (anode) side 41 to the product (cathode) side 43 of the fuel cell 50 and (ii) to oxidize the reduced form of an electron carrier, or the first enzyme can function to transport protons without the reductive activity. The first enzyme 62 can be immobilized in the biocompatible membrane with the appropriate orientation to allow access of the catalytic site for the oxidative reaction to the fuel side and asymmetric pumping of protons. However, if the first enzyme is not asymmetrically oriented, the reverse oriented enzyme is not detrimental for a variety of reasons depending on the context. First, the charge imbalance created by the fuel cell on the anode side drives proton transport to the cathode side even against a proton concentration gradient. In situations where the pumping is tied to the use of fuel (reduced electron carrier), the reverse pumping has no fuel since as the electron carrier is substantially isolated on the fuel side 41. (By “substantially isolated” those of ordinary skill will recognize sufficiently isolated to allow the fuel cell to operate.) The biocompatible membrane can incorporate more than one type of enzyme, as indicated with second enzyme 63 in the schematic.

As illustrated in FIG. 3E, the electrodes can be usefully placed at locations separated from the anode cathode barrier.

In operating the fuel cell of the invention, a number of modes apply:

1. The dehydrogenase enzymes act with bound or non-bound electron carrier(s) (cofactor) that are effective to directly transfer electrons to the anode electrode. Such cofactors are believed to include quinone-based cofactors such as are used in C1-metabolizing microbial enzymes. [Bound and non-bound electron carriers will be recognized by the those of skill in the art as those that reside association with the enzyme during redox cycles, and those that exchange off the enzyme to complete redox cycles, respectively.]

2. The dehydrogenase enzymes act with bound or non-bound electron carrier(s) (cofactor) that are effective to directly transfer electrons to electron transfer mediator(s) that directly transfer the electrons to the anode electrode or directly to second electron transfer mediator(s) more effective to act on the anode electrode (either such electron transfer mediators deemed to be effective to deliver electrons to the anode electrode).

3. The dehydrogenase enzymes act with non-bound electron carrier(s) (cofactor) that are then acted upon by a redox enzyme (which may or may not be part of a biocompatible membrane), which transfers the electrons to a second electron carrier(s). Such electron transfer mediator(s) directly transfer the electrons to the anode electrode or directly to second electron transfer mediator(s) more effective to act on the anode electrode.

4. The dehydrogenase enzymes act with non-bound electron carrier(s) (cofactor) that are then acted upon by a redox enzyme (which may or may not be part of a biocompatible membrane), which transfers the electrons to electron transfer mediator(s). Such electron transfer mediator(s) directly transfer the electrons to the anode electrode or directly to second electron transfer mediator(s) more effective to act on the anode electrode.

As should be apparent, the electron carriers or electron transfer mediators effective to directly transfer electrons to the anode electrode can be determined experimentally by directly providing the reduced form (without generation from fuel). Similarly, compounds that spontaneously transfer electrons between one another can be determined with appropriate chemical analysis after contacting the reduced form of a first compound with the oxidized form of a second compound.

Examples of useful redox enzymes providing one or both of the oxidation/reduction and proton pumping functions include, for example, NADH dehydrogenase (“complex I”) (e.g., from E.coli. Tran et al., “Requirement for the proton pumping NADH dehydrogenase I of Escherichia coli in respiration of NADH to fumarate and its bioenergetic implications,” Eur. J. Biochem. 244: 155, 1997), NADPH transhydrogenase, proton ATPase, and cytochrome oxidase and its various forms, and the like. Methods of isolating such an NADH dehydrogenase enzyme are described in detail, for example, in Braun et al., Biochemistry 37: 1861-1867, 1998; and Bergsma et al., “Purification and characterization of NADH dehydrogenase from Bacillus subtilis,” Eur. J. Biochem. 128: 151-157, 1982. As described by Spehr et al., Biochemistry 38:16261-16267, 1999, the complex I NADH dehydrogenase (or, NADH:ubiquinone oxidoreductase), which is expressed from a operon, can be overexpressed in E. coli by substituting a T7 promoter in the operon to provide useful quantities for use in the invention. Complex I can be isolated from over-expressing E. coli by the method described by Spehr et al. using solubilization with dodecyl maltoside.

Complex I can be handled such that NADH dehydrogenase activity is eliminated or greatly reduced. As described in Böttcher et al., “A Novel, Enzymatically Active Conformation of the Escherichia coli NADH:Ubiquinone Oxidoreductase (Complex I),” web published as accepted for publication at wwwjbc.org, 2002 (Manuscript M112357200), in high salt or high pH solution Complex I changes conformation such that proton transport is uncoupled from NADH dehydrogenase activity, creating DH-form. Applicants have used these conditions and combinations of these conditions to show that the fuel cell of the invention operates without NADH dehydrogenase activity in the anode/cathode barrier. Such conditions include salt concentrations of 200 mM to 2M, and pH of 8.0 or above. Transporter activity is believed to function against a countering [H⁺] gradient, due to the charge imbalance between the anode and cathode sides. Proton transporter activity of the DH⁻ form has been confirmed from the maintenance of current generation in fuel cells in which biocompatible membranes gated by this form provided the only avenue to relieve charge imbalance. (Note that with complex I reverse transport of protons has been further controlled against by using conditions on the cathode side that maintain the NADH dehydrogenase coupling of any inversely oriented complex I—thereby blocking reverse transport due to lack of NADH substrate.)

It will be recognized that the source of any enzyme used in the invention can be a thermophilic organism providing a more temperature stabile enzyme. For example, complex I can be isolated from Aquifex aeolicus in a form that operates optimally at 90° C., as described in Scheide et al., FEBS Letters 512: 80-84, 2002 (describing a preliminary isolation using the type of detergent extraction used elsewhere for complex I).

Additionally, it is contemplated that genetically modified enzymes can be used. One commonly applied technique for genetically modifying an enzyme is to use recombinant tools (e.g., exonucleases) to delete N-terminal, C-terminal or internal sequence. These deletion products are created and tested systematically using ordinary experimentation. As is often the case, significant portions of the gene product can be found to have little effect on the commercial function of interest. It is anticipated that more focused deletions and substitutions can increase stability providing enzymes that can be used in the invention.

The biocompatible membrane can be formed across the perforations 49 and enzyme incorporated therein by, for example, the methods described in detail in Niki et al., U.S. Pat. No. 4,541,908 (annealing cytochrome C to an electrode) and Persson et al., J. Electroanalytical Chem. 292: 115, 1990. Such methods can comprise the steps of: making an appropriate solution of lipid or other amphipathic compounds and enzyme, where the enzyme may be supplied to the mixture in a solution stabilized with a detergent; and, once an appropriate solution of lipid or other amphiphiles and enzyme is made, the perforated dielectric substrate is dipped into the solution to form the enzyme-containing biocompatible membranes. Sonication or detergent dilution may be required to facilitate enzyme incorporation into a biocompatible membrane. See, for example, Singer, Biochemical Pharmacology 31: 527-534, 1982; Madden, “Current concepts in membrane protein reconstitution,” Chem. Phys. Lipids 40: 207-222, 1986; Montal et al., “Functional reassembly of membrane proteins in planar lipid bilayers,” Quart. Rev. Biophys. 14: 1-79, 1981; Helenius et al., “Asymmetric and symmetric membrane reconstitution by detergent elimination,” Eur. J. Biochem. 116: 27-31, 1981; Volumes on biomembranes (e.g., Fleischer and Packer (eds.)), in Methods in Enzymology series, Academic Press.

Existing methods of forming biocompatible membranes tend to share a commonality. A thin partition made (preferably but not necessarily) of a hydrophobic material such as Teflon with a small aperture has a small amount of lipid (or other amphiphile) introduced. The lipid-coated aperture is immersed in a dilute electrolyte solution upon which the lipid droplet will thin and spontaneously self-orient into a planar bilayer spanning the aperture. Biocompatible membranes of substantial area have been prepared using this general technique. Two common methods for formation of the biocompatible membranes themselves are the Langmuir-Blodgett technique and the injection technique.

The Langmuir-Blodgett technique involves the use of a Langmuir-Blodgett trough with a partition, such as a Teflon™ polymer partition at the center. The trough is filled with aqueous solution. The aperture of the polymer partition is placed above the water level. The lipid or other amphipathic component solution (BLM solution) is spread over the surface and the polymer partition is lowered slowly into the aqueous solution forming a biocompatible membrane (“BLM”) over the aperture. The injection method is similar except the polymer partition is kept fixed. In this method the aqueous phase is filled to just under the aperture, the BLM solution is introduced over the surface and then the liquid level is raised over the partition by injecting additional electrolyte solution from underneath, thus forming the BLM over the aperture.

Another method for forming biocompatible membranes is using the technique of self-assembly. This is a variation from the above two described techniques and was in fact the first technique to be successfully employed to fabricate synthetic lipid membranes. The technique involves the preparation of a lipid forming solution much the same as those described above. A drop of the solution is introduced into a perforated hydrophobic substrate. The substrate is then immersed in a dilute aqueous electrolyte solution whereupon the droplet will spontaneously thin and self assemble such that a symmetric layer forms with the polar heads of the lipid molecules (or other amphiphiles) oriented outward toward the aqueous phase and the nonpolar tails oriented inwards. The remaining material migrates to the perimeter of the layer where it forms a reservoir called the Plateau-Gibbs border.

Further, as described by Hui et al., U.S. Pat. No. 5,919,576, hybrid biocompatible membranes can be formed on immobilized lipid (other amphiphiles) by incubating the immobilized lipid with isolated membranes. Enzymatic activities from the isolated membrane source are retained in the hybrid biomembranes.

Biocompatible membranes can also be formed from appropriate block copolymers, such as A-B, A-B-A or A-B-C block copolymers. One suitable block copolymer is described in a series of articles by Corinne Nardin, Wolfgang Meier and others. Angew Chem Int. Ed. 39: 4599-4602, 2000; Langmuir 16: 1035-1041, 2000; Langmuir 16: 7708-7712, 2000. The functionalized poly(2-methyloxazoline)-block-poly(dimethylsiloxane)-block-poly(2-methyloxazoline) triblock copolymer described is as follows

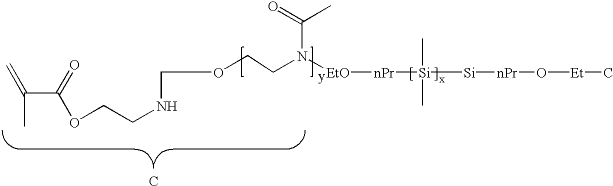

In the above chemical formula, the average x value is 68, and the average y value is 15. The “C” recited does not necessarily equate with the “C” designation of an A-B-C block copolymer. Embodiments of the invention include such A-B, A-B-A or A-B-C polymers in which the average molecular weight of A (or C) is, for example, 1,000 to 3,000 daltons, and the average molecular weight of B is 2,000 to 10,000 daltons. More generally, however, the hydrophobic/hydrophilic balance is selected to (i) provide a solid at the anticipated operating temperature and (ii) promote the formation of biomembrane-like structures over micelles. For this latter function, it is anticipated that generally the hydrophobic component mass shall exceed the hydrophilic component mass. This polymer has been shown to provide relatively large membranes that can incorporate functional three-subunit pore-forming proteins. The methacrylate moieties at the ends of the polymer molecules allow for free-radical mediated crosslinking after incorporating protein to add greater mechanical stability. Moreover, non-ionic biocompatible membranes such as these have greater stability to higher voltage differences across the anode/cathode barrier. Note that despite often being two to three times (or more) thicker than conventional biomembranes, biocompatible membranes formed with these polymers have been found to support the activity of such membrane-associated polypeptides as complex I.

One method of forming a biocompatible membrane, which is preferred for use with block copolymer-based membrane, is as follows:

1. Form a solution of block copolymer in solvent (BC solution). The solution can be a mixture of two or more block copolymers. The solution preferably contains 1 to 90% w/v copolymer, more preferably 2 to 20%, or yet more preferably 5 to 10%, such as 7%.

2. Make proton pumping polypeptide (typically with solubilizing detergent) solution in the prepared BC solution, preferably by adding 0.5 to 5.0 mg/mL of the proton pumping polypeptide (such as complex I), more preferably 1.0 to 4.0 mg/mL. (With amounts preferably selected so that polypeptide comprises up to 10% by weight of the biocompatible membrane after formation.)

3. Drop a small volume (e.g., 4 microliter) polypeptide/BC solution onto each aperture or each of a subset of apertures, and allow to dry, thereby removing the solvent.

4. Repeat step 3 as needed to cover all apertures.

5. Check each aperture under the microscope. Repair holes using BC solution and a micropipette-scaled pipetting device. It typically requires only a very small volume of BC solution to repair such holes. With experience, however, few if any repairs are needed.

The solvent is selected to be miscible with both the water component used in the process and the B component of the block copolymer. Appropriate solvents are believed to include methanol, ethanol, 2-propanol, 1-propanol, tetrahydrofuran, 1,4-dioxane, solvent mixtures that can include more apolar solvents such as dichloromethane so long as the mixture has the appropriate miscibility, and the like. (Solvent components that have any tendency to form protein-destructive contaminants such as peroxides can be appropriately purified and handled.) Solvent typically comprises 10% v/v or more of the applied polypeptide/BC solution, preferably 20% or more, and usefully 30% or more.

The above-described method of introducing polypeptide to a solution containing non-aqueous solvent(s) in the presence of block copolymers serves to stabilize the function of catalytic polypeptides. The non-aqueous components can comprise all of the solvent.

Where the biocompatible membrane incorporates cross-linking moieties, the following procedure can be used:

1. Prepare biocompatible membrane in a support that with form the cathode/anode barrier.

2. Assemble a cell with biocompatible membrane on anode/cathode barrier support, electrodes and buffers only.

3. Connect the two electrodes to a high load, such as approximately 150 kilo-Ohms.

4. Add hydrogen peroxide to cathode side, for example such that the concentration of the peroxide will be 1% by volume.

5. Let fuel cell stand under load for a period of time, for example 1 hour (+10%).

6. Adjust pH of the cathode side to below pH 5 to stops the crosslinking.

Parameters can be adjusted depending on such conditions as the membrane material, the size of biocompatible membrane segments, the structure of the support, and the like.

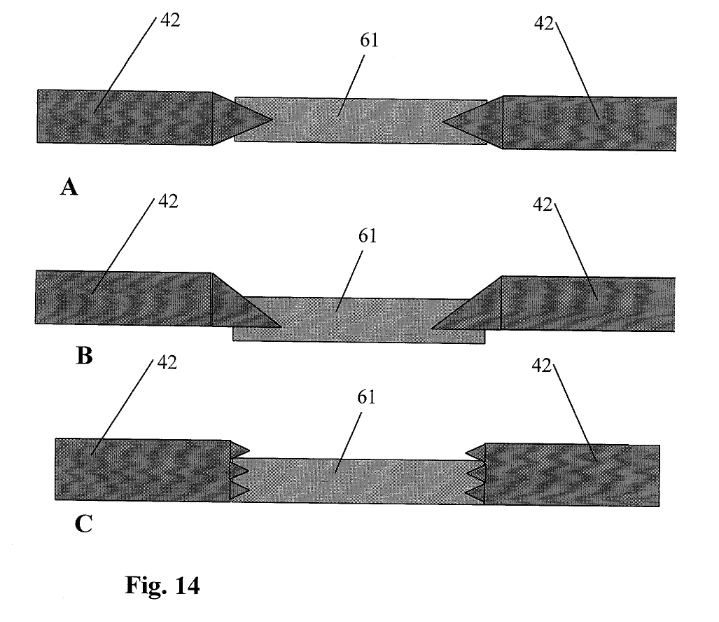

In one embodiment, as shown in FIGS. 14A to 14C, the biocompatible membrane 61 contains cross-linking moieties and is formed across an aperture with beveled edges to the substrate 42. The degree of beveling can be any degree that increases the stability of the biocompatible membrane. Where the cross-linked block copolymer is relatively less rigid, greater beveling can be used to increase stability, while a lessor amount of beveling can be appropriate for more rigid cross-linked block copolymer. As illustrated, numerous beveling shapes can contribute to increasing stability.

The mixtures of block copolymers can be mixtures of two or more of the following classes, where the separate components can be of the same class but with a different distribution of polymer blocks:

| Polymer | Source |
|---|---|
| triblock copolymers E/EP/E, of | |
| poly(ethylene)(E) and | |
| poly(ethylenepropylene)(EP) | |
| Triblock copolyampholytes from 5- | Bieringer et al., Eur. Phys. J.E. |
| (N,N-dimethylamino)isoprene, | 5:5-12, 2001. Among such polymers |
| styrene, and methacrylic acid | are Ai₁₄S₆₃A₂₃, Ai₃₁S₂₃A₄₆, |
| | Ai₄₂S₂₃A₃₅, Ai₅₆S₂₃A₂₁, Ai₅₇S₁₁A₃₂ |
| Styrene-ethylene/butylene-styrene | (KRATON) G 1650, a 29% styrene, |
| triblock copolymer | 8000 solution viscosity (25 wt % |
| | polymer), 100% triblock styrene- |
| | ethylene/butylene-styrene (S-EB-S) |
| | block copolymer; (KRATON) |
| | G 1652, a 29% styrene, 1350 |
| | solution viscosity (25 wt % |
| | polymer), 100% triblock S-EB-S |
| | block copolymer; (KRATON) G |
| | 1657, a 4200 solution viscosity (25 |
| | wt % polymer), 35% diblock S-EB-S |
| | block copolymer; all available from |
| | the Shell Chemical Company. Such |
| | block copolymers include the styrene- |
| | ethylene/propylene (S-EP) types and |
| | are commercially available under the |
| | tradenames (KRATON) G 1726, a |
| | 28% styrene, 200 solution viscosity |
| | (25 wt % polymer), 70% diblock |
| | S-EB-S block copolymer; |
| | (KRATON) G-1701X a 37% styrene, |
| | >50,000 solution viscosity, 100% |
| | diblock S-EP block copolymer; and |
| | (KRATON) G-1702X, a 28% |
| | styrene, >50,000 solution viscosity, |
| | 100% diblock S-EP block copolmyer. |
| Siloxane triblock copolymer | PDMS-b-PCPMS-b-PDMSs |
| | (PDMS = polydimethylsiloxane, |
| | PCPMS = poly(3-cyanopropyl- |
| | methylsiloxane) can be prepared |
| | through kinetically controlled |
| | polymerization of hexamethylcyclo- |
| | trisiloxane initiated by lithium |
| | silanolate endcapped PCPMS macro- |
| | initiators. The macroinitiators can be |
| | prepared by equilibrating mixtures of |
| | 3-cyanopropylmethylcyclosiloxanes |
| | (DxCN) and dilithium diphenyl- |
| | silanediolate (DLDPS). DxCNs can |
| | be synthesized by hydrolysis of 3- |
| | cyanopropylmethyldichlorosilane, |
| | followed by cyclization and |
| | equilibration of the resultant |
| | hydrolysates. DLDPS can be |
| | prepared by deprotonation of |
| | diphenylsilanediol with |
| | diphenylmethyllithium. Mixtures of |
| | DxCN and DLDPS can be |
| | equilibrated at 100° C. within 5-10 |
| | hours. By controlling the |
| | DxCN-to-DLDPS ratio, macro- |
| | initiators of different molecular |
| | weights are obtained. The major |
| | cyclics in the macroinitiator |
| | equilibrate are tetramer (8.6 ± 0.7 |
| | wt %), pentamer (6.3 + 0.8 wt %) |
| | and hexamer (2.1 ± 0.5 wt %). |
| | 2.5k-2.5k-2.5k, 4k-4k-4k, and |
| | 8k-8k-8k triblock copolymers have |
| | been characterized. These triblock |
| | copolymers are transparent, |
| | microphase separated and highly |
| | viscous liquids. |
| PEO-PDMS-PEO triblock | Formed from Polyethylene oxide |
| copolymer | (PEO) and polydimethyl siloxane |
| | (PDMS). |
| Functionalized poly(2- | Angew Chem Int. Ed. 39: |
| methyloxazoline)-block- | 4599-4602, 2000; Langmuir 16: |
| poly(dimethylsiloxane)-block- | 1035-1041, 2000. These |
| poly(2-methyloxazoline) triblock | A-B-Apolymers include versions in |
| copolymer | which the A components have MW |
| | of approximately 2 kd, and the B |
| | component of approximately 5 kd, |
| | and (b) the A components have MW |
| | of approximately 1 kd, and the B |
| | component of approximately 2 kd |
| Poly(d/l-lactide)(“PLA”)-PEG- | |
| PLA triblock copolymer | |
| Poly(styrene-b-butadiene-b- | |
| styrene) triblock copolymer | |
| Poly(ethylene oxide)/ | Such polymers included Pluronic |
| poly(propylene oxide) triblock | F127, Pluronic P105, or Pluronic |
| copolymers | L44 from BASF (Performance |
| | Chemicals). |
| PDMS-PCPMS-PDMS | A series of epoxy and vinyl |
| (polydimethylsiloxane- | endcapped polysiloxane triblock |
| polycyanopropylmethylsiloxane) | copolymers with systematically |
| triblock copolymer | varied molecular weights can be |
| | synthesized via anionic |
| | polymerization using LiOH as an |
| | initiator. |
| polydiene-polystyrene-polydiene | Available as Protolyte A700 from |
| | DAIS-Analytic, Odessa, FL. |
| Azo-functional styrene-butadiene- | |
| HEMA triblock copolymer | |
| Amphiphilic triblock copolymer | |
| carrying polymerizable end groups | |
| Syndiotactic polymethyl- | |
| methacrylate (sPMMA)- | |
| polybutadiene (PBD)- | |
| sPMMA triblock copolymer | |
| Tertiary amine methacrylate | |
| triblock | |
| Biodegradable PLGA-b-PEO-b- | |
| PLGA triblock copolymer | |
| Polyactide-b-polyisoprene-b- | |
| polyactide triblock copolymer | |
| Poly(isoprene-block-styrene-block- | |
| dimethylsiloxane) triblock | |
| copolymer | |
| Poly(ethylene oxide)-block- | |
| polystyrene-block-poly(ethylene | |
| oxide) triblock copolymer | |
| Poly(ethylene oxide)-poly(THF)- | |
| poly(ethylene oxide) triblock | |
| copolymer | |
| Ethylene oxide triblock | |
| Poly E-caprolactone | Birmingham Polymers, |
| | Birmingham, AL. |
| Poly(DL-lactide-co-glycolide) | Birmingham Polymers. |
| Poly(DL-lactide) | Birmingham Polymers. |
| Poly(L-lactide) | Birmingham Polymers. |
| Poly(glycolide) | Birmingham Polymers. |
| Poly(DL-lactide-co-caprolactone) | Birmingham Polymers. |
| Styrene-Isoprene-styrene triblock | Japan Synthetic Rubber Co., Tokyo, |
| copolymer | Japan; MW = 140 kg/mol; Block |
| | ratio of PS/PI = 15/85. |
| PMMA-b-PIB-b-PMMA | Poly(methyl methacrylate) (PMMA) |
| | and polyisobutylene (PIB). |
| PLGA-PEO-PLGA triblock | Polymers of poly(DL-lactic |
| copolymer | acid-co-glycolic acid) (PLGA) |
| | and PEO. |
| Sulfonated styrene/ethylene- | |
| butylene/styrene (S-SEBS) triblock | |
| copolymer proton conducting | |
| membrane | |
| Poly(l-lactide)-block-poly(ethylene | |
| oxide)-block-poly(l-lactide) | |
| triblock copolymer | |
| Poly-ester-ester-ester triblock | |
| copolymer | |
| PLA/PEO/PLA triblock copolymer | The synthesis of the triblock |
| | copolymers can be prepared by |
| | ring-opening polymerization of |
| | DL-lactide or e-caprolactone in |
| | the presence of poly(ethylene glycol), |
| | using no-toxic Zn metal or calcium |
| | hydride as co-initiator instead of the |
| | stannous octoate. The composition of |
| | the copolymers can be varied by |
| | adjusting the polyester/polyether |
| | ratio. |

The above polymers can be used in mixtures of two or more of polymers in the same or different class. For example, in two polymer mixtures measured in weight percent of the first polymer, such mixtures can comprise 10-15%, 15-20%, 20-25%, 25-30%, 30-35%, 35-40%, 40-45% or 45-50%. Or, for example where three polymers are used: the first can comprise 10-15%, 15-20%, 20-25%, 25-30%, 30-35%, 35-40%, 40-45% or 45-50% of the whole of the polymer components, and the second can 10-15%, 15-20%, 20-25%, 25-30%, 30-35%, 35-40%, 40-45% or 45-50% of the remainder.

Biocompatible membranes can be formed against a solid material, such as by coating onto glass, carbon that is surface modified to increase hydrophobicity, or a polymer (such as polyvinyl acetate, PDMS, Kapton®, a perfluorinated polymer, PVDF, PEEK, polyester, or UHMWPE, polypropylene or polysulfone). Polymers such as PDMS provide an excellent support that can be used to establish openings on which biocompatible membranes can be formed.

Coating methods which can be used to form electrodes include a first coating or lamination of conductor, followed by plating, sputtering or using another coating procedure to coat with titanium or a noble conductor such as gold or platinum. Another method is directly sputtering an attachment layer, such as chromium or titanium onto the support, followed by plating, sputtering or other coating procedure to attach a noble conductor. The outer metal layer can be favorably treated to increase its hydrophobicity, such as with dodecane-thiol.

Supports with high natural surface charge densities, such as Kapton and Teflon, are in some embodiments preferred. As noted above, these can be used to form the anode/cathode barrier without the use of surface electrodes.

Using polypeptides having both the oxidation/reduction and proton pumping functions, and which consume electron carrier, the acidification of the fuel side caused by the consumption of electron carrier is offset by the export of protons from the anode to the cathode. Net proton pumping in conjunction with reduction of an electron carrier can in some circumstances exceed 2 protons per electron transfer—assuming in this instance coupling to electron transfer. If needed, in some embodiments care must be taken to buffer or accommodate excess de-acidification on the fuel side or excess acidification of the product side.

Applicants have shown that biologically catalyzed proton transfer can occur against large gradients (pH 8 or higher at anode side to pH 5 or lower at cathode side).

Additionally, the invention can be operated using more traditional means for transporting or otherwise conveying protons to the cathode chamber. For example, the intermediate chamber can comprise a proton-conducting solid polymer electrolyte membrane (a proton-conductive polymeric membrane). Such a proton-conductive polymeric membrane can be formed of Nafion™ polymer (discussed above). Also useful are perfluorinated sulfonic acid polymer membranes such as Aciplex™ (manufactured by Asahi Glass Co., Japan) and polymer membranes made by Dow Chemical Co., USA, such as XUS 13204.10, which are similar in properties to Nafion™. Proton-conductive polymeric membranes of polyethylene and polypropylene sulfonic acid, polystyrene sulfonic acid and other polyhydrocarbon-based sulfonic acids (such as membranes made by RAI Corporation, USA) can also be used depending on the temperature and duration of fuel cell operation. Composite proton-conductive polymeric membranes consisting of two or more types of proton-conducting cation-exchange polymers with differing acid equivalent weights, or varied chemical composition (such as modified acid group or polymer backbone), or varying water contents, or differing types and extents of cross-linking (such as cross linked by multivalent cations e.g., Al 3+, Mg 2+etc.,) can be used to achieve low fuel permeability. Such composite proton-conductive polymeric membranes can be fabricated to achieve high ionic conductivity, low permeability for the liquid fuel and good electrochemical stability. As described further below, enzyme-mediated active proton transport can be used in conjunction with proton conductive polymer membranes.

The electrodes can be formed by directly depositing a conductive material onto one or each side of an appropriate proton-conductive polymeric membrane separating the anode and cathode sides of a fuel cell. One such deposition method, which utilizes a polymer ink containing platinum, platinum-ruthenium, or the like, is described in Chun et al., WO 99/39841.

Reduced transmission of feeder molecules (such as methanol) from the anode chamber to the cathode chamber can be obtained by appropriate selection of the material (e.g., dielectric) intervening between the anode and cathode electrodes. Yen, WO 97/19480, for example, teaches sulfated and crosslinked poly ethyl ether ketone (PEEK) polymers and sulfated and crosslinked poly (p-phenylene ether sulfone) (PES) polymers that conduct protons, but have reduced methanol permeability. (Yen's polymer addressed the high solvent transport his group encountered with Nafion™ polymers operating at higher temperatures (above 60° C.) than needed in the present invention.) Similarly, Prakash, WO 98/22989 describes proton-conductive polymeric membranes made of sulfated polystyrene crosslinked with divinylbenzene to achieve reduced methanol transmission. A “pore-plugging” approach to limiting methanol transmission is described in Kindler, WO 99/40237. Where the electron acceptor molecule is gaseous oxygen, the membrane can be treated to enhance water repellency, thereby reducing water infiltration to the cathode chamber, as described by Kindler, U.S. Pat. No. 5,992,008. Additional proton-conductive polymeric membranes for excluding methanol crossover are described in Banerjee et al., U.S. Pat. No. 5,672,438.

The perforations in the barrier can be used to support the biocompatible membranes discussed above, or can open into a proton-conductive polymeric membrane. A mix of biologically-based proton conduction and passive proton conduction can be used to moderate the balance between proton consumption, proton production and proton transport.

In another embodiment, redox enzymes are placed in the anode compartment, optionally deposited on or adjacent to the first electrode, while a proton transporter is incorporated into the biocompatible membranes on the perforations.

The perforations 49 are illustrated as openings. However, these can also comprise porous segments of the dielectric substrate 42. Alternatively, these can comprise polymeric membranes spanning the perforations 49 to support the biocompatible membrane. Preferably, enzyme density in the biocompatible membrane is high.

The orientation of polypeptide in the biocompatible membrane can be random, with effectiveness of proton pumping dictated by the asymmetric presence of substrate such as protons and electron carrier. Alternatively, orientation is established for example by using antibodies to the enzyme present on one side of the membrane during formation of the enzyme-biocompatible membrane complex.

The perforations 49 and metallized surfaces (first electrode 44 and second electrode 45 (for embodiments that use so-located electrodes)) of the dielectric substrate 42 can be constructed, for example, with masking and etching techniques of photolithography well known in the art. Perforations can also be formed, for example, by punching, drilling, laser drilling, stretching, and the like. Alternatively, the metallized surfaces (electrodes can be formed for example by (1) thin film deposition through a mask, (2) applying a blanket coat of metallization by thin film then photo-defining, selectively etching a pattern into the metallization, or (3) photo-defining the metallization pattern directly without etching using a metal impregnated resist (DuPont Fodel process, Drozdyk et al., “Photopatternable Conductor Tapes for PDP Applications,” Society for Information Display 1999 Digest, 1044-1047; Nebe et al., U.S. Pat. No. 5,049,480). In one embodiment, the dielectric substrate is a film. For example, the dielectric can be a porous film that is rendered non-permeable outside the “perforations” by the metallizations. The surfaces of the metal layers can be modified with other metals, for instance by electroplating. Such electroplatings are, for example, with titanium, gold, silver, platinum, palladium, mixtures thereof, or the like. In addition to metallized surfaces, the electrodes can be formed by other appropriate conductive materials, which materials can be surface modified. For example, the electrodes can be formed of carbon (graphite), including graphite fiber, which can be applied to the dielectric substrate by, for example, electron beam evaporation, chemical vapor deposition or pyrolysis. Surfaces to be metallized can be solvent cleaned and oxygen plasma etched. Useful means of forming hydrophilic electrodes are described for example in Surampudi, U.S. Pat. No. 5,773,162, Surampudi, U.S. Pat. No. 5,599,638, Narayanan, U.S. Pat. No. 5,945,231, Kindler, U.S. Pat. No. 5,992,008, Surampudi, WO 96/12317, Surampudi, WO 97/21256 and Narayanan, WO 99/16137.

Biomembrane layers (e.g., biocompatible membranes including lipid membranes) used in the invention are optionally stabilized against a solid support. One method for accomplishing such stabilization uses sulfur-mediated linkages of lipid-related molecules to metal surfaces to tether biocompatible membranes. For example, a porous support can be coated with a sacrificial or removable filler layer, and the coated surface smoothed by, for example, polishing. Such a porous support can include any of the proton-conductive polymeric membranes discussed, typically so long as the proton-conductive polymeric membrane can be smoothed following coating, and is stable to the processing described below. One useful porous support is glass frit. The smoothed surface is then coated (with prior cleaning as necessary) with metal, such as with a first layer of chrome and an overcoat of gold. The sacrificial material is then removed, such as by dissolution, taking with it the metallization over the pores but leaving a metallized surface surrounding the pores. The sacrificial layer can comprise photoresist, paraffin, cellulose resins (such as ethyl cellulose), and the like.

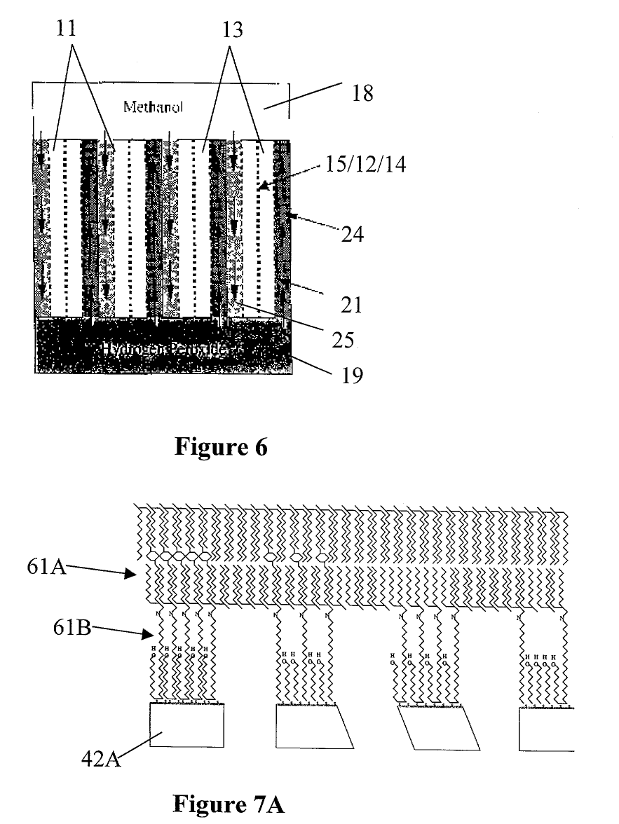

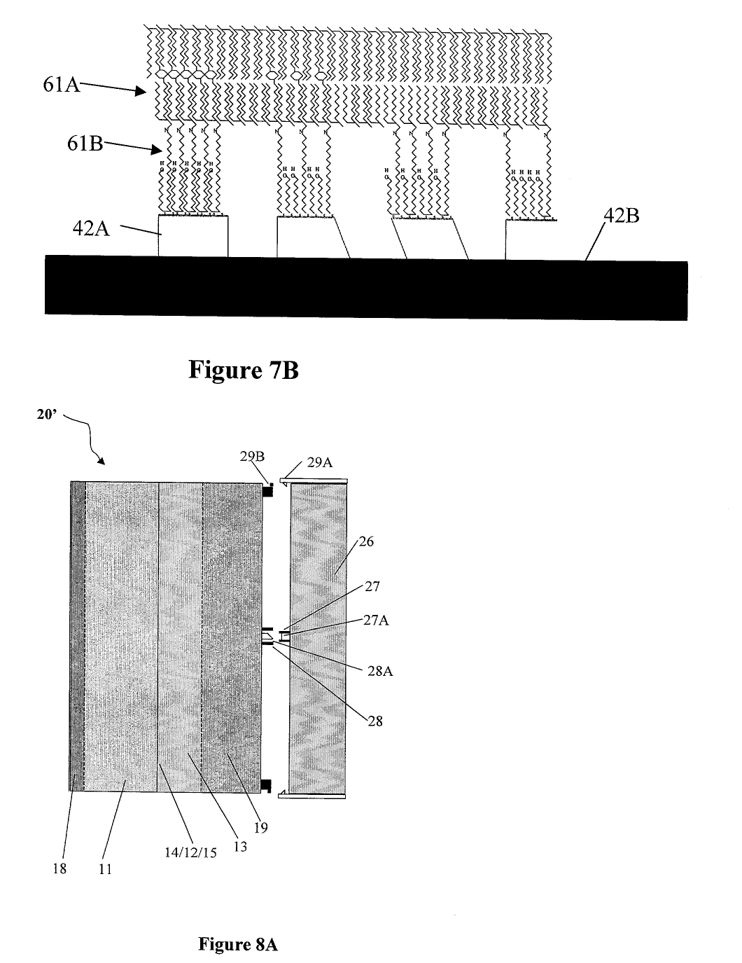

The tether comprises alkyl thiol, alkyl disulfides, thiolipids and the like adapted to tether a biocompatible membrane as illustrated if FIGS. 7A and 7B. Such tethers are described for example in Lang et al., Langmuir 10: 197-210, 1994. Additional tethers of this type are described in Lang et al., U.S. Pat. No. 5,756,355 and Hui et al., U.S. Pat. No. 5,919,576.

In operating fuel cells of the invention, Applicants believe that, at the cathode side, one or both of tetramethyl ammonium salt and Tris can provide cations, while one or all of sulfate, chloride and phosphate can provide anions. At the anode side, Applicants believe that one or all of tetramethyl ammonium formate, Tris formate, Tris hydrochloride, tetramethyl ammonium chloride, MES buffer and HEPES-KOH buffer can be used. Appropriate concentrations, and additional components such as NaCl can be determined through ordinary experimentation.

In one embodiment of the invention, a dehydrogenase enzyme having proton-pumping capacity is directly associated with a proton-conductive polymeric membrane, such as the sulfonated polymers described above. For example, the biocompatible membrane can be stabilized against the proton-conductive polymeric membrane. In one embodiment, the biocompatible membrane is tethered to the proton-conductive polymeric membrane as described above. With thiol-mediated tethers, a sputtered partial coating of gold can provide the anchor.

Where the cathode compartment is adapted to operate with hydrogen peroxide as the electron acceptor molecule, the electrode is preferably free of surface metal. For example, a graphite electrode can be used. Otherwise, for example, the cathode electrode coatings can, for example, include titanium, platinum or any noble metal, or a non-metallic conductor such as graphite or a conductive polymer.

As illustrated in FIG. 3C, electrical contact 54 connects the first electrode 44 to a prospective electrical circuit, while electrical contact 55 connects the second electrode 45.

In one embodiment, the cathode side of the fuel cell is comprised of an aqueous liquid with dissolved oxygen or hydrogen peroxide. For oxygen, one can use an emulsion containing a composition which effectively dissolves oxygen (e.g., see, Riess, et al., Fluorocarbon-Based In Vivo Oxygen Transport and Delivery Systems Vox Sang, 61:225-239 (December 1991), and Weers, et al., U.S. Pat. No. 5,914,352).

The use of simple feeder molecules and high energy density electron acceptor molecules allows a simple way to restore power by replacing these fluids. As described in copending Serial No. 60/339,118, filed Dec. 11, 2001, hydrogen peroxide can be used as a source for O₂.

-The above discussion of the embodiments using proton transport focus on the use of both faces of a substrate to provide the electrodes, thereby facilitating a more immediate transfer of protons to the product side where the protons are consumed in reducing the electron acceptor molecules. However, it will be recognized that in this embodiment structures such as a porous matrix can be interposed between the fuel side and the product side. Such an intervening structure can operate to provide temperature shielding or scavenger molecules that protect, for example, the enzymes from reactive compounds. The porous matrix is, for example, made up of inert fibers such as asbestos, sintered materials such as sintered glass or beads of inert material. Or, the porous matrix is an electrolyte membrane materials such as one of those discussed above.

The fuel cell operates within a temperature range appropriate for the operation of the redox enzyme or proton transporter. This temperature range typically varies with the stability of the enzyme, and the source of the enzyme. To increase the appropriate temperature range, one can select the appropriate redox enzyme from a thermophilic organism, such as a microorganism isolated from a volcanic vent or hot spring. Additionally genetically modified enzymes can be used. Nonetheless, preferred temperatures of operation of at least the first electrode are about 80° C. or less, preferably 60° C. or less.

The anode electrode can be coated with an electron transfer mediator (including electron carriers serving as electron transfer mediators) such as an organometallic compound which functions as a substitute electron recipient for the biological substrate of the redox enzyme. Similarly, the biocompatible membrane of the embodiment of FIG. 3 or structures adjacent to the biocompatible membrane can incorporate such electron transfer mediators, or the electron transfer mediator can be more generally available in the anode chamber. Such organometallic compounds can include, without limitation, dicyclopentadienyliron (C₁₀H₁₀Fe, ferrocene, available along with analogs that can be substituted, from Aldrich, Milwaukee, Wis.), platinum on carbon, and palladium on carbon. Further examples include ferredoxin molecules of appropriate oxidation/reduction potential, such as the ferredoxin formed of rubredoxin and other ferredoxins available from Sigma Chemical. Other electron transfer mediators include organic compounds such as quinone and related compounds. Still further electron transfer mediators are methylviologen, ethylviologen or benzylviologen (CAS 1102-19-8; 1,1′-bis(phenylmethyl)-4,4′-bipyridinium, N,N′-γ,γ′-dipyridylium), and any listed below in the definition of electron transfer mediator.

The anode electrode can be impregnated with the redox enzyme, which can be applied before or after the electron transfer mediator. One way to assure the association of the redox enzyme with the electrode is simply to incubate a solution of the redox enzyme with electrode for sufficient time to allow associations between the electrode and the enzyme, such as Van der Waals associations, to mature. Alternatively, a first binding moiety, such as biotin or its binding complement avidin/streptavidin, can be attached to the electrode and the enzyme bound to the first binding moiety through an attached molecule of the binding complement. Additional methods of attaching enzyme to electrodes or other materials, and additional electron transfer mediators are described in Wilner and Katz, Angew. Chem. Int. Ed. 39:1181-1218, 2000. The anode chamber can include feeder enzyme or enzymes adjacent to or associated with the anode electrode, or separate therefrom. For example, the redox enzyme or feeder enzyme can be attached to the anode chamber side of a polymer forming a proton conductive anode/cathode barrier, with a layer of conductive material on the anode side providing the anode electrode. In some embodiments of the invention, it is anticipated that the electron carrier will be effective to transfer electrons to the anode electrode in the absence of redox enzyme.

The redox enzyme can comprise any number of enzymes that use an electron carrier as a substrate, irrespective of whether the primary biologically relevant direction of reaction is for the consumption or production of such reduced electron carrier, since such reactions can be conducted in the reverse direction. Examples of redox enzymes further include, without limitation, glucose oxidase (using NADH, available from several sources, including number of types of this enzyme available from Sigma Chemical), glucose-6-phosphate dehydrogenase (NADPH, Boehringer Mannheim, Ind.polis, Ind.), 6-phosphogluconate dehydrogenase (NADPH, Boehringer Mannheim), malate dehydrogenase (NADH, Boehringer Mannheim), glyceraldehyde-3-phosphate dehydrogenase (NADH, Sigma, Boehringer Mannheim), isocitrate dehydrogenase (NADH, Boehringer Mannheim; NADPH, Sigma), and α-ketoglutarate dehydrogenase complex (NADH, Sigma).

The redox enzyme can also be a transmembrane pump, such as a proton pump, that operates using an electron carrier as the energy source. In this case, enzyme can be associated with the electrode in the presence of detergent and/or lipid carrier molecules which stabilize the active conformation of the enzyme. As in other embodiments, an electron transfer mediator can be used to increase the efficiency of electron transfer to the electrode.

The redox enzyme or feeder enzyme can be adjacent to or associated with the anode electrode or separate therefrom. Adjacency includes being incorporated into a polymeric membrane linked to or contacting the anode electrode. The redox enzyme can include one of the feeder enzymes. For example, the redox enzyme or feeder enzyme can be attached to the anode chamber side of a polymer forming a proton conductive anode/cathode barrier, with a layer of conductive material on the anode side providing the anode electrode. Suitable coupling methods include those described by Willner and Katz, Angew Chem Int. Ed. 39: 1180-1218, 2000.

The associated electron carriers are readily available from commercial suppliers such as Sigma and Boehringer Mannheim. The concentrations at which the reduced form of such electron carriers can be as high as needed to optimize the function of the redox enzyme. The salt and buffer conditions are designed based on, as a starting point, the ample available knowledge of appropriate conditions for the redox enzyme. Such enzyme conditions are typically available, for example, from suppliers of such enzymes.

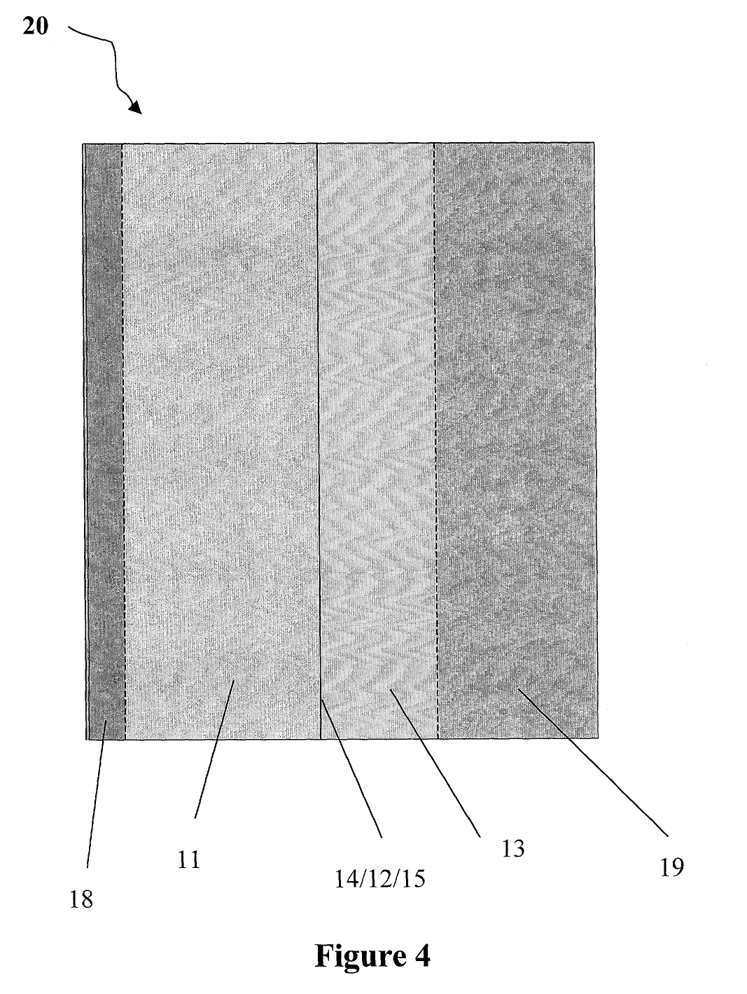

FIG. 4 schematically illustrates an exemplary fuel cell 20. Anode chamber 11 is associated with an optional fuel source (FS) reservoir 18, which provides fuel such as, without limitation, methanol, when the fuel concentration in the anode chamber 11 becomes reduced. The location of the anode electrode 14, intermediate chamber/dielectric layer 12, and the cathode electrode 15 are indicated. Cathode chamber 13 is associated with optional electron acceptor molecule (EA) reservoir 19, which provides electron acceptor molecules, such as, without limitation, hydrogen peroxide, when the concentration in the cathode chamber 13 becomes reduced.

In the anode chamber, the feeder enzymes can be in solution or fixed to a support, such as polymer particles that fill the anode chamber, or incorporated into a matrix (such as a hydrogel matrix, such as PEG or polyacrlyamide). The concentration of fuel maintained in the anode chamber is selected on the basis of a number of factors such as the effect on enzyme efficiency, the concentration needed to assure kinetic factors do not lead to at least localized concentration drops in fuel or electron carrier molecules (reduced form) affecting performance, the amount that enzyme efficiency losses can be addressed with excess enzyme, effects on redox enzymes, and the like. In the FS reservoir, the concentration of fuel can be neat, diluted with water in an amount selected to provide a replacement for the H₂O consumed in the feeder reactions (for MeOH fuel fully consumed to CO₂, 1 mol water (18 mL) per mol MeOH(40.6 mL)), or have a greater degree of dilution with water. In this context, “an amount selected to provide a replacement for the H2O consumed in the feeder reactions” means the replacement amount determined empirically to provide continuing operation of the fuel cell. Or, fuel concentration in the FS reservoir can be reduced to the degree that occurs during the life of the fuel cell or a cycle of the life of the fuel cell due to liquid flows back into the FS reservoir. Fuel concentration in the fuel side (in the anode chamber) is selected to allow sufficiently effective operation of the enzymes used to extract energy. Where the fuel is an alcohol, the concentration in the anode chamber is selected to allow a useful turnover rate for the enzymes in use, and not disrupt the integrity of any biocompatible membrane.

The concentration of electron acceptor molecules in the cathode chamber is, where the electron acceptor molecule is a peroxide, selected on such factors as the amount that can be introduced without contacting undue amounts with the biologically-derived molecules at the anode electrode. The cathode electrode can be designed so that the flow pathway through the electrode brings many surfaces for electron transfer (and hence quenching) near any prospective pathway for peroxide. In the EA reservoir, where the electron acceptor molecule is a peroxide, the concentration can be the highest commercially available in an appropriate grade, or less. For example, for hydrogen peroxide, the concentration can be any commercially available concentration, such as 60% (w/w) or 30%. Note that with hydrogen peroxide, the pH of the cathode chamber is preferably kept low, such as pH 5, 4, 3 or lower.

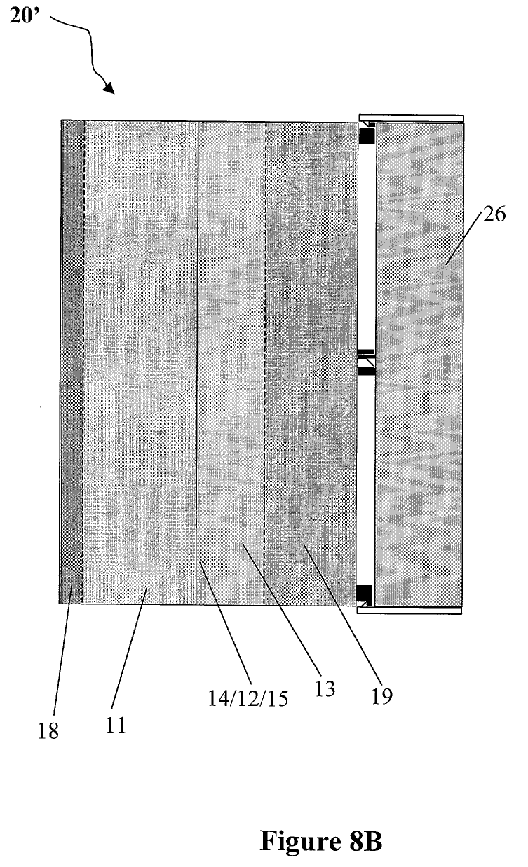

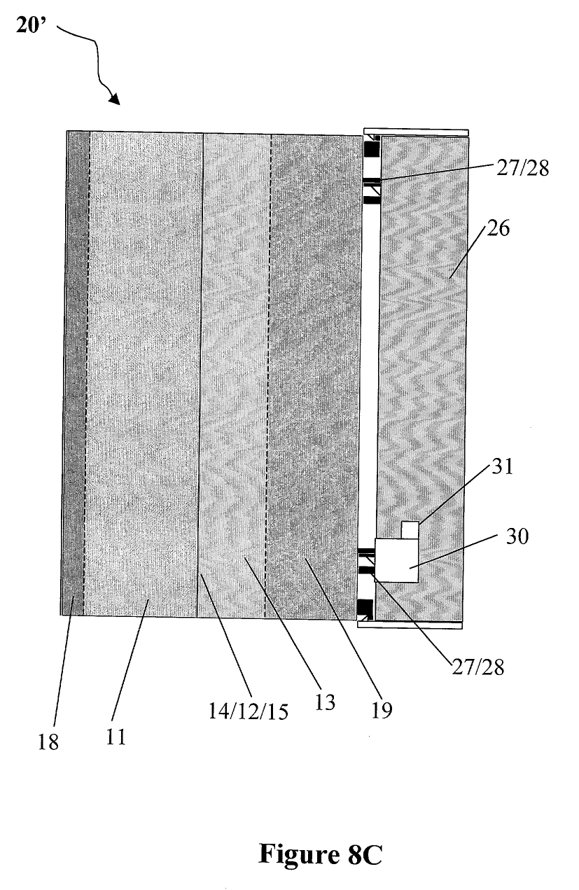

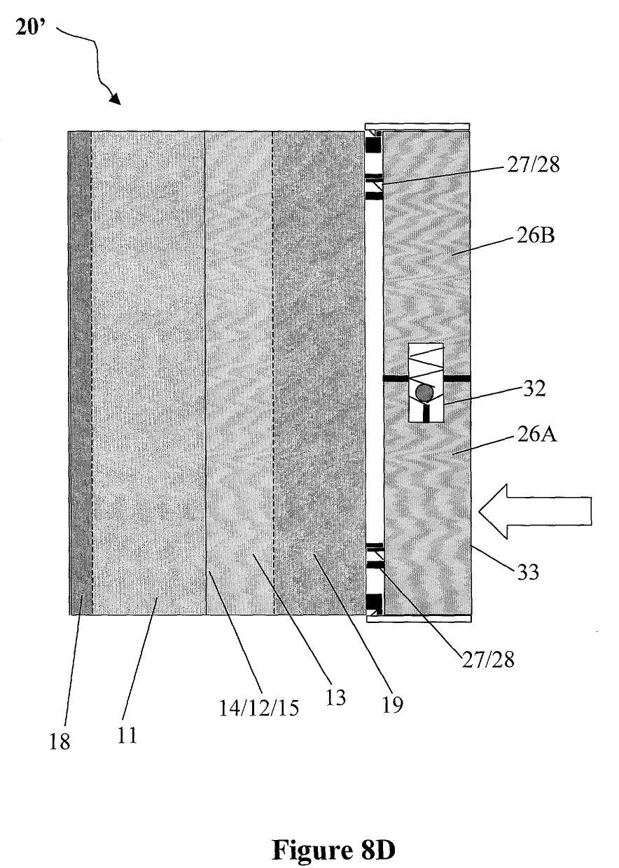

FIGS. 8A to 8D illustrate how the electron acceptor molecules (as illustrated) or fuel can be replaced. As will be recognized, corresponding structures are available on the fuel side. In the illustrations of FIGS. 8A and 8B, an external reservoir 26 is fitted to EA reservoir 19 using fitting 28 which has a bevelled proboscis structure 28A. Fitting 28 fits into second fitting 27, which as a seal 27A that is pierced by proboscis structure 28A. As will be understood, any number of coupling devices can be used. The devices can have a seal for at least the external reservoir pierced with the coupling operation. The external reservoir is illustrated as secured by locking elements 29A and 29B. Any number of locking mechanisms can be used, including screw fittings and locking elements integrated into the first and second fittings, such as are found in Luer™-lock fittings. Fluid flow between the more permanent parts of the fuel cell and the external reservoir(s) can be accentuated by using two or more fluid connections, as illustrated in FIG. 8C. FIG. 8C also illustrates the use of a pump 30 with intake/outlet 31 to pump fluid between the external reservoir 26 and EA reservoir 19. The pump can be operated initially, typically using electrical power drawn from the operation of the fuel cell, intermittently as appropriate to enhance or synchronize with power production, or constantly during power production. Other methods can be used to assure transport, such as the externally operated system illustrated in FIG. 8D, in which check valve 32 (which can be any check valve, though illustrated as a spring-loaded check valve) operates to assure that pressure applied (such as by the force vector illustrated with the arrow) to a flexible surface of the device (such as surface 33) induces flow, such as from sub-reservoir 26A to sub-reservoir 26B. Such devices as pumps or check valves can have resistance to flow when not in operation such that fluid leakage is minimized when an external reservoir is removed (e.g., vertically lifted off of the fuel cell). It should be apparent that the anode chamber EA reservoir 19, cathode chamber, or FS reservoir 18 can be of minimum size, such as no more than required plumbing, or absent, when external reservoirs are used.

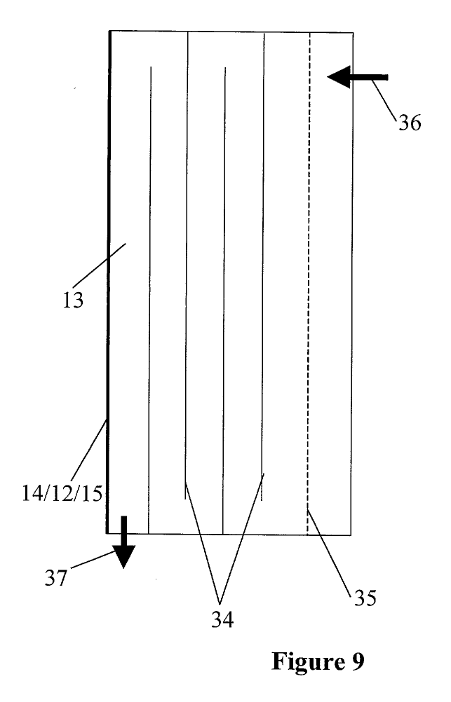

The chambers can contain baffles, such as illustrated with baffles 34 for a cathode chamber 13 in FIG. 9. The same arrangement can be used in the anode chamber. The baffles serve to direct exhausted fluid to an exit point 37 that can be controlled with pumps or check valves. Fresh fluid is inserted upstream such as at intake 36, which can be controlled with pumps or check valves. A diffuser 35 can be used to help distribute the fresh fluid.

Pumps used to regulate fluid flow can be micro-diaphragm pumps, such as are available from Dr. Peter Woias of Fraunhofer IMS, Munich, Germany or Institut fur Mikrotechnik Mainz GmbH, Mainz, Germany.

Multi-Tiered Proton Conductive Membranes

The biocompatible membrane with incorporated proton pumping enzyme provides one form of anode/cathode barrier. As noted, some embodiments of the invention use a more traditional form of anode/cathode barrier: a polymeric membrane selected for it ability to passively conduct protons. The former anode/cathode barrier is useful since it is effective to pump against a proton gradient.

It has now been observed that desirable results are obtained when dual membranes or barriers form across the pores of an anode/cathode barrier. These membranes can be of the traditional composition or biocompatible membranes. One context in which such dual membranes are observed are those in which the pores are of relatively narrow diameter. Another context is one in which the anode cathode barrier is formed of sandwiched materials such that separate junctions between differing materials nucleate the formation of separate biocompatible membranes across the pore.

Without limitation to theory, it is believed that the second, more cathode proximate biocompatible membrane, operates to some degree passively, as the pumping from the first biocompatible membrane creates a high proton concentration, driving passive transport to the cathode compartment. Thus, to the extent the cathode compartment contains peroxide that could prospectively damage the transport protein, the active transport function can be damaged, while the second biocompatible membrane insulates the first from higher concentrations of the peroxide.

In one embodiment, the dual membrane benefit is obtained with one or more biocompatible membranes, the first of which (at the anode side) incorporates the active transport enzyme, and a proton-conductive polymeric membrane fitted at the cathode chamber side to limit peroxide transit towards the biocompatible membranes. Again, an intermediate zone between the biocompatible membrane(s) and the proton-conductive polymeric membrane gains a high proton concentration due to active transport, driving further transit along a concentration gradient into the cathode compartment.

In one embodiment, the substrate in which the pores are formed is a sandwich of dielectric Kapton, and conductive Kapton (conductive through the presence of incorporated graphite). The conductive Kapton can form the anode electrode, or be appropriately metallized to form the anode electrode. The three layers are relatively hydrophilic, relatively hydrophobic, then relatively hydrophilic.

Regulating Delivery of Fuel From the FS or EA Reservoir

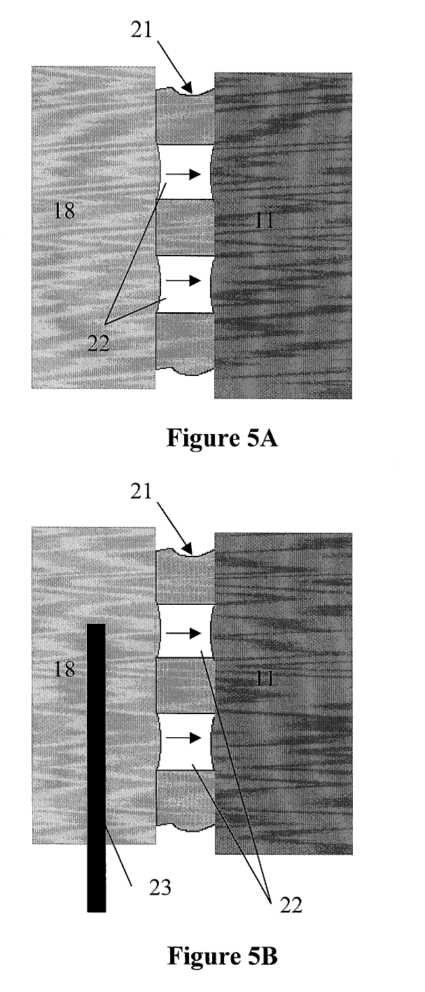

One mechanism for delivering fuel to the anode chamber 11 uses a porous membrane 21 that is not wetted by either the fuel of the FS reservoir and the solvent/solution of the anode chamber, as illustrated in FIGS. 5A and 5B. For example, the membrane can be formed of perfluoro polymer, such as Teflon, or a polyethylene polymer (“PE”) such as ultra high molecular weight polyethylene (“UHMWPE”)(a term recognized in the art; see J. J. Coughlan, and D. P. Hug, “Ultra-high molecular weight polyethylene,” in Encyclopaedia of Polymer Science and Engineering, New York, John Wiley & Sons, 1986, pp. 490-494). Thus, transfer across the membrane 21 is via the vapor phase transmitted through pores 22. The fuel can be selected to have a higher vapor pressure at the operating temperature, assuring that the highest transmission rate is in the desired direction, indicated with the arrows. A heater 23, such as a resistance heater, can be operated from excess power production from the fuel cell to heat the fuel adjacent to the membrane to increase transmission. The same mechanism can be used to meter electron acceptor composition to EA reservoir 13. Pore diameters are preferably from 0.02 to 2 micron, more preferably from 0.2 to 1 micron. Pores are formed, for example, by laser drilling, stretching, and the like.

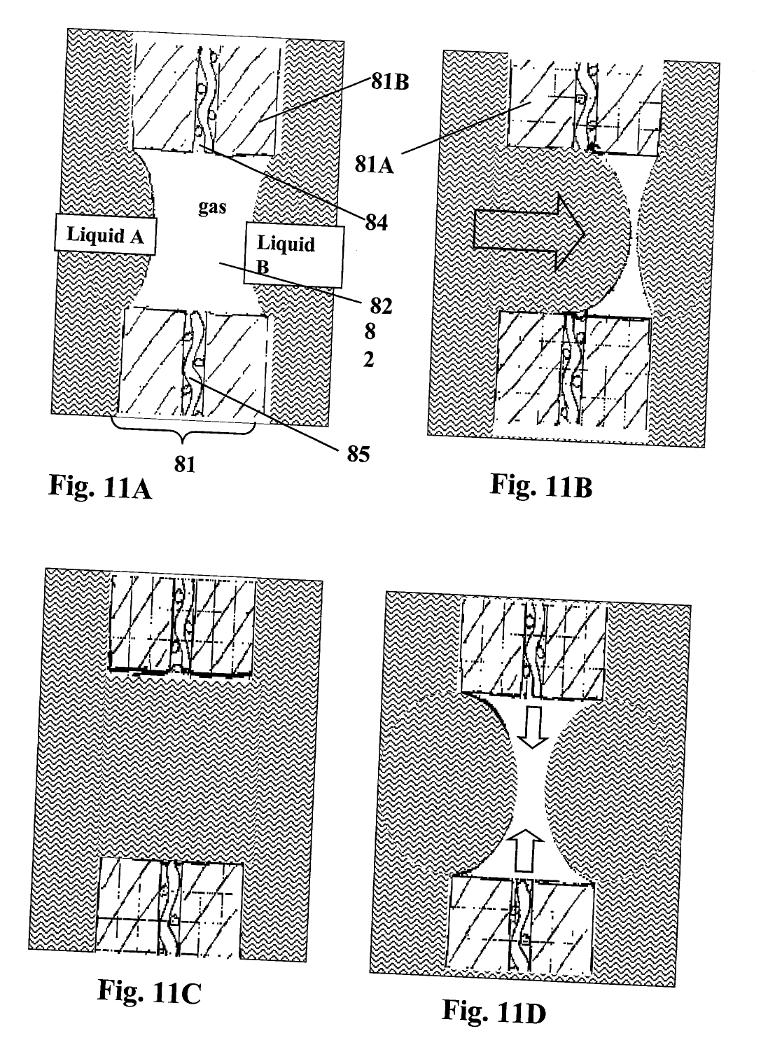

Another form of transport from a reservoir to a reaction chamber (or another chamber intermediate to the reaction chamber) is illustrated in FIGS. 11A-11D. This transport device and method, like the others described in this application, can be used in any device needing reactant transport from a reservoir to a reaction chamber. As illustrated, the reactant concentrate, Liquid A, is separated from the liquid in the reaction chamber, Liquid B, by membrane 81, which is a composite structure. Internal conduit 84 is adapted to deliver gas to pores 82 that connect Liquid A to Liquid B. Optionally, the material forming the membrane 81 can be one not wetted by Liquid A or Liquid B (typically a hydrophobic material), such that the operative principle of the structure of FIGS. 11A and 11B contributes to the operation of this structure. When the reactant concentrate is not needed, such as when the fuel cell is not operating, gas is drawn or injected to assure separation of Liquid A and Liquid B. FIG. 11D illustrates gas insertion, and FIG. 11A, the initial gas-separated state. Gas injection is regulated by pressure, or by amount, utilizing regulator devices and, where appropriate, feedback loops to control electronics, as is known in the art. Or, the lack of wetting of the membrane creates a force drawing in the gas to create separation of Liquid A and Liquid B in the absence of flow-inducing pressure on Liquid A. Liquid A is pressurized (beyond the pressure of the gas) to initiate flow across the pores 82. To end flow across membrane 81, gas is again injected as in FIG. 11D.

To initiate flow across membrane 81, pressure is created in Liquid A, for example with a pump, pressure applied to a deformable outer wall of the Liquid A chamber, injected gas, or using other methods or devices known in the art. The gas injected into the system for pressurizing, or for filling the pores 82 can be removed from the system with the methods used to remove CO₂. The wetting forces that draw in gas create a self-actuating capillary break between Liquid A and Liquid B.

One method of creating the internal conduit 84 is by making the membrane 81 from a sandwich of first solid polymer layer 81A, porous matrix 85 (preferably formed of a material not wetted by Liquid A or Liquid B), and second solid polymer layer 81B. Porous matrix 85 can be a mesh, or a porous polymer material, for example a Teflon or PE foam (such as an UHMWPE foam). Adhesive or heat or ultrasonic welds or the like, for example, are strategically placed to assure the structural integrity of the composite, without interfering with gas flow to the pores. Materials for the solid polymer layers and porous matrix include Teflon, PE (including UHMWPE), and any other polymer with appropriate wetting properties and stability in the intended fuel cell environment. The porous matrix can, for example, be formed of mesh, weave, pressed fiber, or the like, or of a porous material formed, for example, with a foam, sintered fiber, or the like. Diameters for the pores 82 forming the capillary barriers are preferably from 0.5 micron to 100 micron, more preferably from 10 micron to 50 micron. Pores 82 are formed, for example, by punching, drilling, laser drilling, stretching, and the like. The porous matrix 85 can be selected so that the average internal pores that carry gas are from 0.2 micron to 2 micron diameter, more preferably from 0.5 micron to 1 micron.

In enzyme based fuel cells the fuel can be metered into the reaction chamber over a large surface area to promote efficient diffusional mixing. In addition it is desirable to feed multiple cells within the battery from a single reservoir. In order to maintain the battery as compact as possible the cells can be, for example, arranged in a stacked configuration. As illustrated in FIG. 6, anode capillary wicks 25 and cathode capillary wicks 24 can be used to distribute fuel from FS reservoir 18 or electron acceptor molecules from EA reservoir 19, respectively.

The capillary wicking structures are, for example, fabricated out of mats of oriented fibers such as fiberglass. This manner of reactants distribution is unaffected by battery orientation. FIG. 6 shows a battery containing four cells. For illustrative purposes, the fuel and oxidizer are shown in a diametrically opposed orientation. However, the two reservoirs can be oriented at right angles to each other or even stacked on top of each other with proper manifolding. The separate wicks for fuel or electron acceptor molecules can be joined so that the metering process is effected with a single element, simplifying manufacture or, potentially, maintenance. While FIG. 6 illustrates a metering mechanism applied for both the fuel and the electron acceptor molecules, it will be recognized that metering is more important for delivering fuel in those circumstances where the enzymes used are sensitive to the concentration of fuel that would be supplied in the FS reservoir.

If sensing for fuel concentration is needed to regulate fuel delivery, such sensors are described for example in Narayanan, WO 98/45694. Fuel delivery and mixing can, in addition to the methods described above, be done with the devices and methods described for example in Surampudi et al., U.S. Pat. No. 5,599,638 and Surampudi et al., U.S. Pat. No. 5,773,162. Or, concentration control can be conducted using the detector and detector-dependent valve taught in U.S. Pat. No. 4,810,597, or the detector taught in Narayanan et al., WO 98/45694.

The cathode chamber can be expandable, at least within the bounds of any exterior casing, such that any dilution due to the production of water at the cathode electrode can be countered by electron acceptor composition delivered from the EA reservoir.

Any CO₂ generated in the anode chamber can be drawn out by passing fluid (which can include liquid) from the anode chamber through tube of microporous polymer. Such tubes can be made of polymers such as Collardm polymer (Celanese Corp.) or GoreTex™ polymer (porous polytetrafluoroethylene, Gore Association, USA). Tubes that circuit from one location in the walls of the anode chamber to another can be placed so that fluid flow to effect clearance of the gas occurs due to the tendency of the gas to rise and any pressure created due to the gas generated in operation. The exchange of carbonic acid to CO₂ (or the reverse reaction) can be catalyzed by carbonic anhydrase, which can be generally distributed or localized by crosslinking or strong association (e.g., avidin-biotin) with a matrix in the vicinity of CO₂ porous materials (as discussed above on linking enzymes to solid supports) or in the vicinity of CO2 generation. Carbonic anhydrases are well known, including such enzyme from thermophilic organisms. For example, Alber et al. describe “A carbonic anhydrase from the archaeon Methanosarcina thermophila” in Proc. Natl. Acad. Sci. U.S.A. 91: 6909-6913, 1994. The enzyme from human or bovine erythrocytes is commercially available (e.g., Sigma Chemical, St. Louis). In one embodiment, the CO₂ is absorbed onto a suitable CO₂ absorbent, such as Ascarite, a mixture of silica and sodium hydroxide. Such absorbent is preferably integrated into the fuel cartridges so that snapping a fuel cartridge in creates a conduit from the CO₂ exits from the anode chamber to the absorbent.

Where CO₂ is vented directly into the atmosphere, activated charcoal can be used to remove any fuel that might be carried by the CO₂, thus preferably removing fuel odor.

Carbonic anhydrase can be used to stabilize the CO₂ in the dissolved carbonic acid form, for example at the electrodes at which the CO₂ concentration may be high.

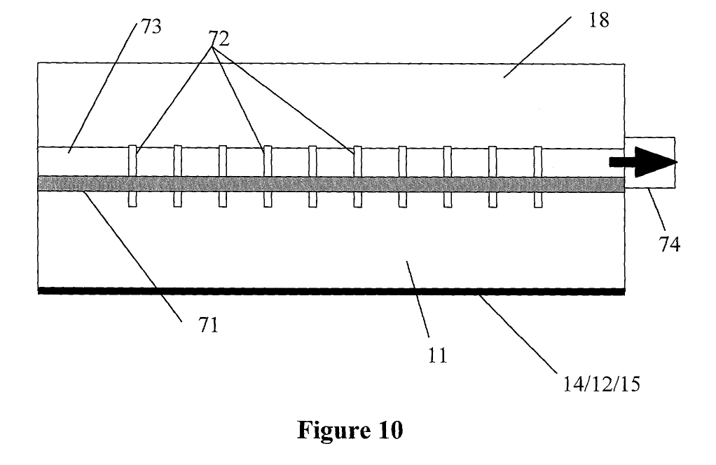

In one embodiment, the consumption of H₂O and fuel, and the withdrawal of CO₂ from the anode chamber 11, driven by the lower free energy of the gaseous state, provides a volume deficit that draws fuel from FS reservoir 18. For example, as illustrated in FIG. 10, CO₂ is drawn through CO₂ transmitting polymeric membrane 71, to CO2 manifold 73, and away as illustrated with the arrow. Fuel-conveying conduits 72, which can incorporate check valves, provide a pathway for fuel to replace CO₂. In one embodiment, an evacuating pump 74, which can be powered by the fuel cell, increases the efficiency with which CO₂ is drawn outward. The pump can be provided by a microdiaphram pump.

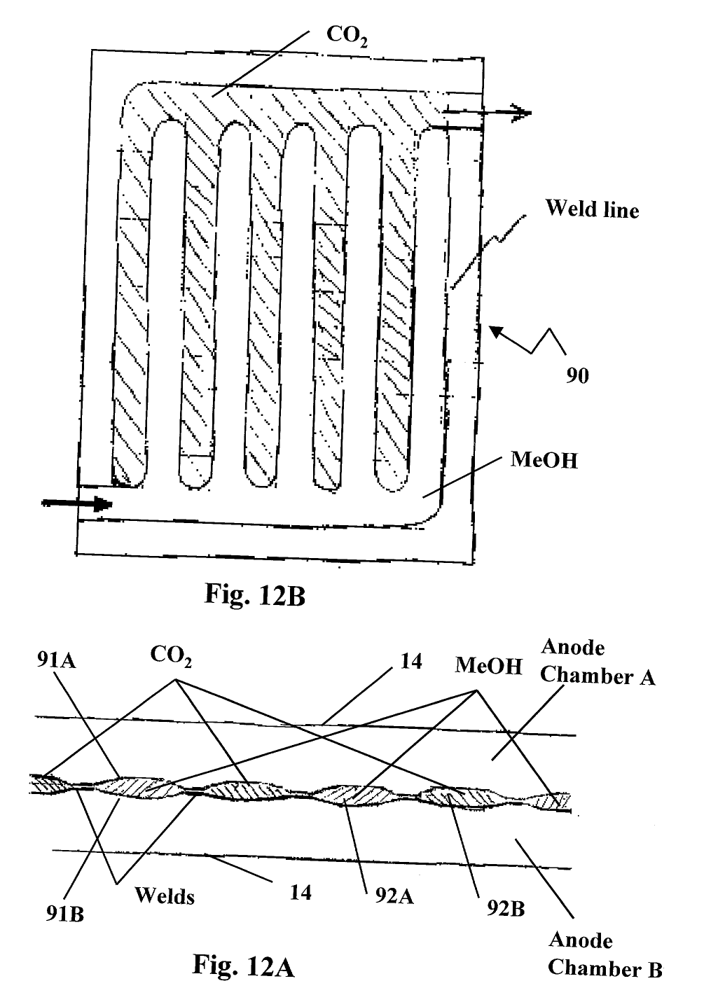

Another fuel distribution and CO₂ removal device 90, illustrated in FIGS. 12A and 12B, can be considered with reference to a stacked cell device such as that illustrated in FIG. 6, except where the ordering is cathode compartment (CC)/electrodes-membranes(EM)/anode compartment (AC)/AC/EM/CC/EM/AC/AC . . . and so on, meaning that each cathode compartment (or a pair adjacent but separated cathode compartments) operates with a cathode electrode on two sides, and each anode electrode is part of an adjacent pair. The AC/AC junction incorporates the device of FIGS. 12A and 12B. A first layer 91A of polymer, preferably one suitable for use in the device of FIG. 5, such that it conveys fuel by vapor transport, is welded to a second layer 91B of, typically but not necessarily, the same polymer. The welds are designed to give interlocking finger shapes, such as illustrated in FIG. 12B. A first set of the finger shapes convey methanol (MeOH) or a substitute fuel, while the second set collects CO₂. The separation of the polymer layers in the finger structures is maintained by first porous medium 92A in the MeOH fingers, and second porous medium 92B in the CO₂ fingers. These porous materials are preferably the same, based on ease of fabrication. First porous medium 92A is preferably a hydrophilic material, such as appropriately surface treated PE fibers or UHMWPE, selected to effectively wick the fuel. (Hydrophilic PE (and UHMWPE) are surface treated to make them hydrophilic, such as by plasma treatment.) The fuel is inserted from a fuel source at the location indicated by an inward arrow. A negative pressure can be applied to the vent indicated by the outward arrow of the CO₂ fingers. As illustrated in FIG. 12A, the distribution and CO₂ removal device 90 is positioned to between two anode electrodes 14. Since the same reactions occur in Anode Chamber A as in Anode Chamber B, the distribution and CO₂ removal device 90 need not, but optionally does, form a sealed (but for the transmissions through the polymer layers), electrically isolating barrier between these chambers.

The device of FIG. 12 can be used to deliver hydrogen peroxide in the cathode compartment. In this case, the CO₂ fingers can be omitted, or used to draw out (by vapor transmission, excess H₂O created by cathode compartment chemistry. Also, the CO₂ removal function can be removed for the anode device (by removing the conduits for CO₂), or the fuel delivery function can be removed (by removing the conduits for fuel) leaving CO₂ removal.

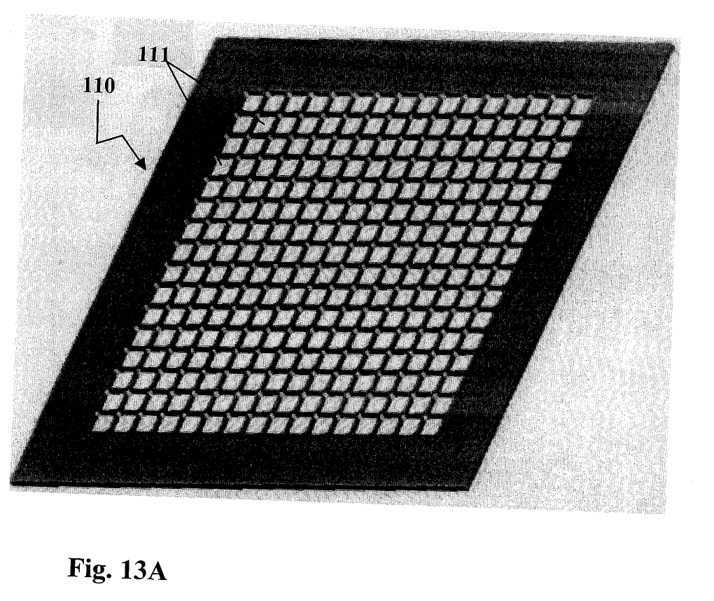

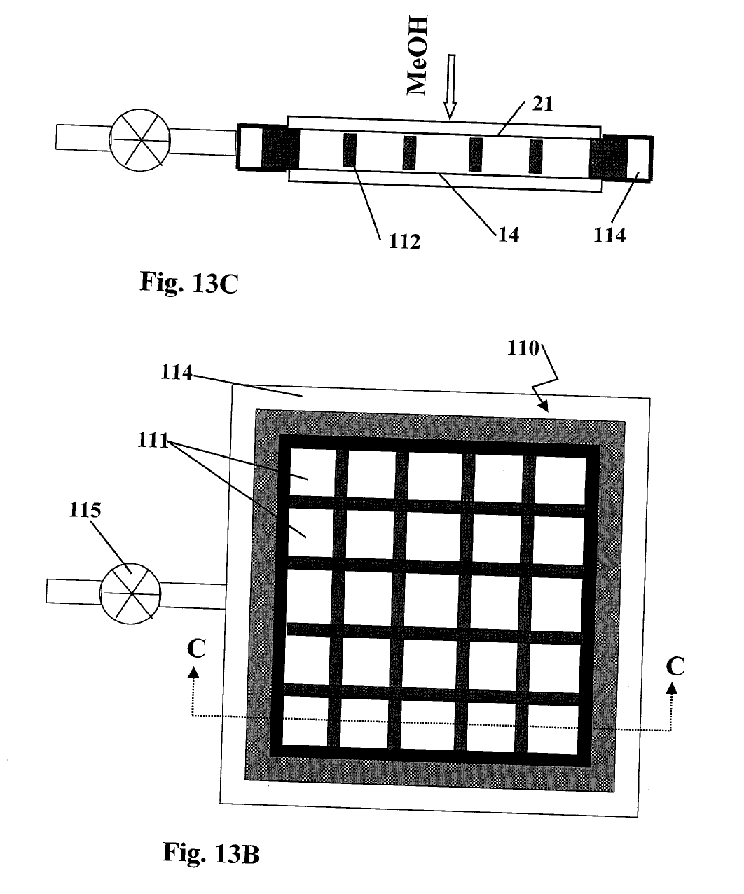

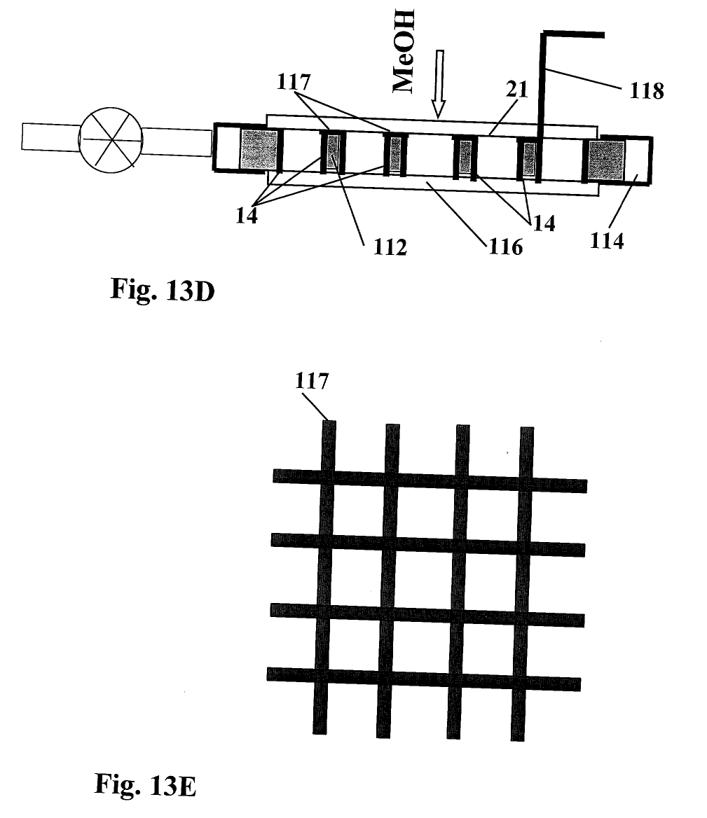

Another device 110 for removing CO₂ is shown in FIG. 13A, which shows a grid support structure that provides a lattice that supports (a) the proton-conveying anode/cathode barrier and (b) a fuel-providing polymeric membrane such as described with respect to FIG. 5. The grid support provides openings 111 between lattice members 112. Preferably, the openings are less than or equal to 6 mm in maximum width, more preferably less than or equal to 3 mm. While a rectangular configuration is illustrated, any number of shapes are useful. The grid support is constructed of a hydrophobic open cell foam material that is porous, with the material and pore size selected to be conductive of CO₂, while resisting the entrance of water and methanol (or other one carbon molecules or precursors thereof that can substitute as a fuel source). As illustrated in FIGS. 13B and 13C, the device 110 can be mounted between an anode/cathode barrier and a membrane 21 that distributes fuel by vapor diffusion. A vacuum manifold 114 can be sealed to the edges, and a vacuum drawn, for instance with pump 115. Exemplary materials for the foam material include UHMWPE foam, and foams of perfluoro polymers, such as Teflon.

In one embodiment, the anode electrode 14 is formed by appropriate conductive material applied to the sides of the lattice members 112. For example, the conductor is applied by sputtering, with the sputtering parameters selected to leave pores for CO₂ extending through the electrode. Current can be drawn through conductor 117, which is seen from a top view in FIG. 13E, and through conductor 118, which can form a circuit with the cathode electrode.

With respect to fuel and oxidant delivery systems, it will be apparent that the invention can be applied to any fuel cells that can usefully use liquid fuel or oxidant metering—so long as the compositions are compatible with the described delivery system. In particular, the invention relates to other fuel cells that use C1 fuel, or hydrogen peroxide oxidant. Similarly, for CO₂ exhaust systems, the described inventions apply to any fuel cell that generates CO₂.

A fuel cell of the invention with 300 mL or less of liquid can include, for example, a 1.0 mL anode chamber and a 1.0 mL cathode chamber. Such a fuel cell can use, for example, 11 mL of methanol (0.27 mole), which can be delivered from a separate FS reservoir. The electron acceptor molecules can be provided by a corresponding amount of hydrogen peroxide, which is 90 mL of 30% H₂O₂ (which can be supplied from an EA reservoir). Such a fuel cell has 50 Wh in chemical energy. Increasing the size of the reservoirs leads to quick increases in chemical energy. A fuel cell with an increase of 200 mL in total volume (to 500 mL) has 150 Wh in chemical energy.

Note that those of ordinary skill will recognize that a number of features are represented in the drawings as planar, but other geometries can be used.

Reconditioning

The fuel cell, in addition to being re-fueled, may on occasion require reconditioning for other components useful to maintain operational efficiency, such as with respect to the electron carrier, electron transfer mediator, salts, buffers, enzymes, and the like.

Definitions

The following terms shall have, for the purposes of this application, the respective meanings set forth below.

electron carrier: An electron carrier is a molecule used to donate electrons in an enzymatic reaction. Electron carriers include, without limitation, reduced nicotinamide adenine dinucleotide (denoted NADH; oxidized form denoted NAD or NAD⁺), reduced nicotinamide adenine dinucleotide phosphate (denoted NADPH; oxidized form denoted NADP or NADP⁺), reduced nicotinamide mononucleotide (NMNH; oxidized form NMN), reduced flavin adenine dinucleotide (FADH₂; oxidized form FAD), reduced flavin mononucleotide (FMNH₂; oxidized form FMN), reduced coenzyme A, and the like. Electron carriers include proteins with incorporated electron-donating prosthetic groups, such as coenzyme A, protoporphyrin IX, vitamin B12, and the like Further electron carriers include gluconic acid (oxidized form: glucose), oxidized alcohols (e.g., ethylaldehyde), and the like. It will be recognized that C1 compounds comprising carbon oxygen and hydrogen are electron carriers. Also within the definition of electron carrier are electron transfer mediators, as specified below.

electron acceptor molecules: An electron acceptor molecule is a compound which receives the electrons conveyed to the cathode by the fuel cell.

electron transfer mediator: An electron transfer mediator is a composition which facilitates transfer of electrons released from an electron carrier to another molecule, typically an electrode or another electron transfer mediator with an equal or lower reduction potential. Examples include phenazine methosulfate (PMS), pyrroloquinoline quinone (PQQ, also called methoxatin), Hydroquinone, methoxyphenol, ethoxyphenol, or other typical quinone molecules, methyl viologen, 1,1′-dibenzyl-4,4′-dipyridinium dichloride (benzyl viologen), N,N,N′,N′-tetramethylphenylenediamine (TMPD) and dicyclopentadienyliron (C10H10Fe, ferrocene).

feeder enzyme: A feeder enzyme is one that generates a reduced electron carrier from (i) the oxidized form and (ii) another organic molecule (feeder molecule) that is oxidized in the process. The feeder molecule is typically a relatively simple molecule.

feeder molecule: A feeder molecule is as defined in the above section on feeder enzymes.

feeder reactions: A feeder reaction is one catalyzed by a feeder enzyme.

membrane associated polypeptide: A membrane associated polypeptide is a polypeptide that normally functions in association with a biological membrane.

redox enzyme: An redox enzyme is one that catalyzes the transfer of electrons from an electron carrier to another molecule, or from another molecule to the oxidized form of an electron carrier. Dehydrogenase enzymes are a specific subclass of redox enzymes.

polypeptide-catalyzed: Reference to polypeptide-catalyzed means that a polypeptide provides the framework for the active site of catalysis, it does not exclude the presence of associated or covalently bound cofactors that participate in catalysis.

synthetic biocompatible membrane: A synthetic biocompatible membrane is a membrane that is partly or completely comprised of amphipathic molecules that are either wholly synthetic or modifications of naturally occurring molecules, in which it is possible to immobilize functional biomolecules, such as polypeptides, lipids, phospholipids or fatty acids. Examples of such biocompatible membranes include block copolymers and thiolipids. In one preferred embodiment, such a biocompatible membrane is one that would not form from the amphipathic molecules present but for the presence of block copolymers

The following examples further illustrate the present invention, but of course, should not be construed as in any way limiting its scope.

### EXAMPLE 1

A fuel cell is formed using a disk formed of Teflon polymer electroplated on both sides with gold (20-mil or 0.5 mm total thickness), with one or more milled apertures through the disk of 0.3 to 1 mm width, such as 0.39 mm. A biomembrane is formed across the apertures with a phospholipid composition dissolved in solvent (in this case, 45% Methanol, 45% chloroform, 10% decane). The organic lipid solution was deposited onto the self-assembled thiol monolayer on an electrode assembly immersed in electrolyte (25 mM Tris-HCl pH 7.0 with 100 mM NaCl), and a layer of the mixture was drawn across the aperture and allowed to thin. Care was taken to maintain sufficiently equal hydrostatic pressure on both sides of the aperture.

Incorporation of the polypeptide (e.g., the proton transporting enzyme complex I) is accomplished by fusion with the biomembrane, in a solution containing 10 mM calcium chloride, of vesicles that contained the polypeptide. Use of calcium as an agent to promote the fusion of vesicles with membranes is well recognized in the art, as illustrated by: Landry et al., “Purification and Reconstitution of Epithelial Chloride Channels,” 191 Methods in Enzymology 572, 582 (1990) (at 582); Schindler, “Planar Lipid-Protein Membranes . . . ,” 171 Methods in Enzymology 225, 226 (1989). More specifically, the vesicles are injected onto the biomembrane, then incubated on the anode side in a relatively small volume, such as 500 microliter. This is essentially the method of Landry et al. (at 582), or Schindler (at 236). The protein-containing vesicles are prepared by incubating a detergent solution of the protein with vesicles that had been freshly formed from lipids using sonication. This is essentially the method described in Schindler at 252 (which uses vortexing instead of sonication). This method has been successfully applied to incorporate complex I as obtained from over-expressing E. coli into a stable membrane formed across a perforation in a Teflon barrier.

The test device, with anode and cathode compartments, was constructed from Delran plastic, with the compartments separated by the aperture-containing disk described above. The disk was sealed in place with rubber gaskets. Connections were made to an electrometer, using gold connecting wires in parallel with an electronically varied external load. Power has been generated using 3.3 mM NADH as fuel with 2 mM benzyl viologen in the anode compartment to act as the electron transfer mediator.

### EXAMPLE 2

The device of Example 1 is used with a membrane formed of a biocompatible membrane formed of non-lipid polymers, as described in U.S. Serial No. 60/283,823. Such compositions, when composed primarily on non-ionic species, are particularly preferred for fuel cells that generate higher voltages.

All publications and references, including but not limited to patents and patent applications, cited in this specification are herein incorporated by reference in their entirety as if each individual publication or reference were specifically and individually indicated to be incorporated by reference herein as being fully set forth. Any patent application to which this application claims priority is also incorporated by reference herein in its entirety in the manner described above for publications and references. The priority applications and certain other co-owned applications that copended with the priority applications are also incorporated by reference in their entirety; these are: No. 60/283,823, Apr. 13, 2001 (Dkt. 367952-101P); No. 60/283,717, Apr. 13, 2001 (Dkt. 367952-102P); No. 60/339,117, Dec. 11, 2001 (Dkt. 367952-102PA); No. 60/283,786, Apr. 13, 2001 (Dkt. 367952-103P); No. 60/357,481, Feb. 15, 2002 (Dkt. 367952-103PA); No. 60/283,719, Apr. 13, 2001 (Dkt. 367952-104P); No. 60/357,367, Feb. 15, 2002 (Dkt. 367952-107P).

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A fuel cell system comprising (1) a fuel cell with an anode compartment and a cathode compartment adapted to operate with a least one liquid consumable comprising (i) a liquid fuel composition or (ii) liquid electron acceptor composition, and:
(2) one or both of (a) a fuel reservoir comprising liquid fuel composition separated from the anode compartment by a porous membrane that is selected to not be wetted by either the liquid fuel composition or a solvent/solution with which the anode chamber is adapted to operate or (b) a liquid fuel composition reservoir separated from the cathode compartment by a porous membrane that is selected to not be wetted by either the liquid fuel composition or a composition with which the cathode chamber is adapted to operate.

2. The fuel cell system of claim 1, comprising multiple said fuel cells adapted to receive one or both of fuel and hydrogen peroxide from corresponding said reservoirs.

3. The fuel cell system of claim 1, wherein the liquid fuel composition comprises C₁ compoundas fuel

4. The fuel cell system of claim 1, wherein the liquid electron acceptor composition comprises hydrogen peroxide.

5. A fuel cell system comprising
a fuel cell with an anode compartment and a cathode compartment and using one or both of (a) a liquid fuel composition or (b) a liquid electron acceptor composition, the fuel cell comprising:
in the anode compartment, an anode electrode adapted to operate with a fuel;
in the cathode compartment, a cathode electrode which, when a conductive pathway to the anode electrode is formed, is effective to convey the electrons to an electron acceptor composition in the cathode compartment; and
a barrier separating the anode compartment from the cathode compartment but effective to convey protons from the anode compartment to the cathode compartment; and
one or both of (a) a fuel reservoir comprising a liquid fuel composition separated from the anode compartment by a porous membrane that is selected to not be wetted by either the liquid fuel composition or a solvent/solution with which the anode chamber is adapted to operate or (b) a liquid electron acceptor composition reservoir separated from the anode compartment by a porous membrane that is selected to not be wetted by either the liquid electron acceptor composition of the reservoir or a composition with which the cathode chamber is adapted to operate.

6. The fuel cell system of claim 5, wherein the fuel cell has a said reservoir for fuel.

7. The fuel cell system of claim 6, wherein the fuel is C₁ compound or precursor.

8. The fuel cell system of claim 7, wherein the fuel cell has a said reservoir for the C₁ compound.

9. The fuel cell system of claim 8, wherein the C₁ compound is methanol.

10. The fuel cell system of claim 8, wherein the solution in the fuel reservoir consists essentially of methanol and water.

11. The fuel cell system of claim 10, wherein the solution in the fuel reservoir comprises an amount of water adapted to substantially replace the water consumed in operating the fuel cell.

12. The fuel cell system of claim 5, comprising multiple said fuel cells adapted to receive one or both of fuel and liquid electron acceptor from corresponding said reservoirs.

13. The fuel cell system of one of claims 5 or 12, wherein the reservoir of (a) or (b) is formed by two layers polymer, at least one of which is said porous membrane, welded together to provide conduits between the layers for the liquid fuel composition or liquid electron acceptor composition.

14. The fuel cell system of claim 13, wherein the two layer structure further comprises conduits for removing CO₂.

15. The fuel cell system of claim 14, further comprising a CO₂ absorbent positioned to collect CO₂ from said CO₂ removing conduits.

16. The fuel cell system of claim 5, wherein the fuel cell has a said reservoir for liquid electron acceptor composition.

17. The fuel cell system of claim 16, wherein the liquid electron acceptor is a hydrogen peroxide composition.

18. A method of operating a fuel cell comprising:
consuming (i) a fuel molecule or (ii) an electron acceptor molecule during operation of the fuel cell; and
transporting (i) fuel molecule or (ii) electron acceptor molecule via the vapor phase to a chamber in which the respective fuel molecule or electron acceptor molecule is consumed.

19. The method of claim 18, wherein the fuel molecule is C₁ compound or precursor.

20. The method of claim 18, wherein the electron acceptor molecule is hydrogen peroxide.

21. A fuel cell system comprising
a fuel cell with an anode compartment and a cathode compartment, the fuel cell comprising:
in the anode compartment, an anode electrode, wherein the anode compartment is adapted to generate CO₂;
in the cathode compartment, a cathode electrode which, when a conductive pathway to the first electrode is formed, is effective to convey the electrons to an electron acceptor composition in the cathode compartment; and
a barrier separating the anode compartment from the cathode compartment but effective to convey protons from the anode compartment to the cathode compartment; and
a CO₂ permeable membrane or porous material adapted to allow CO₂ to exit the anode compartment.

22. The fuel cell system of claim 21, further comprising:
a reservoir for C₁ compound or precursor separated from the anode compartment by one or more channels.

23. The fuel cell system of claim 22, wherein the one or more channels have check valves preventing flow from the anode compartment into the reservoir.

24. The fuel cell system of claim 21, comprising multiple said fuel cells adapted to exhaust CO₂ through said CO₂ permeable membrane.

25. The fuel cell system of one of claims 21 or 24, further comprising:
a CO₂ collecting manifold; and
a pump for removing CO₂ from the manifold.

26. The fuel cell system of one of claims 21 or 24, further comprising:
a CO₂ collecting manifold; and
CO₂ absorbent positioned to collect CO₂ from manifold.

27. A method of operating a fuel cell comprising:
consuming in an anode compartment a fuel to generate CO₂ during operation of the fuel cell;
removing CO₂ derived from the C₁ compound from the anode compartment; and
replacing liquid volume in the anode compartment consumed by operation of the fuel cell and CO₂ removal with replacement fuel.

28. A device for metering a reactant concentrate comprising:
a first chamber adapted for containing reactant concentrate;
a second chamber adapted for receiving reactant concentrate from the first chamber; and
a membrane separating the first and second chambers comprising pores traversing from a first chamber side of the membrane to a second chamber side of the membrane, and internal conduit in the membrane effective to deliver gas to the pores.

29. A fuel cell comprising an anode chamber and a cathode chamber, the fuel cell adapted for used with a fuel composition and an anode chamber composition, the fuel cell further comprising the device of claim 28 for metering fuel, wherein the anode chamber is the second chamber, and wherein the material of the membrane is selected to resist wetting by the fuel composition and the anode chamber composition, thereby creating a force that acts to draw gas to the pores via the internal conduit.

30. A fuel cell system comprising (1) multiple fuel cells with an anode chamber and a cathode chamber, the fuel cell adapted for used with a fuel composition and an anode chamber composition, and (2) the device of claim 28 for metering fuel into to anode chambers of multiple said fuel cells, wherein the anode chambers are the second chamber, and wherein the material of the membrane is selected to resist wetting by the fuel composition and the anode chamber composition, thereby creating a force that acts to draw gas to the pores via the internal conduit.

31. A fuel cell adapted for use with an anode composition, the fuel cell comprising:
an anode/cathode barrier that selectively transmits protons;
an anode chamber comprising a grid of porous material selected to not be wetted by the anode composition and to transmit CO₂; and
a manifold connected to the grid to collect CO₂ transmitted through the grid.

32. The fuel cell of claim 31, further comprising:
a pump for reducing the pressure in the manifold.

33. The fuel cell of claim 31, further comprising:
an anode electrode formed by a porous coating of conductor on the grid.
